(19) United States
(12) Patent Application Publication
(10) Pub. No.: US 2025/0065985 A1
(43) Pub. Date: Feb. 27, 2025

(54) ELECTRIC SNOWMOBILE

(71) Applicant: Polaris Industries Inc., Medina, MN (US)

(72) Inventors: Lucas Salfer, Salol, MN (US); Chiao George Liu, White Bear Lake, MN (US); Austin Bartz, Forest Lake, MN (US); Troy Pierce, Roseau, MN (US); Eric J. Borud, Roseau, MN (US); Cole J. Maxwell, Roseau, MN (US); Corey D. Omdahl, Roseau, MN (US); Jeremy R. Eichenberger, Warroad, MN (US); Jeffrey A. Eaton, Roseau, MN (US); Scott R. Mooney, Roseau, MN (US); Richard A. Fredrickson, Roseau, MN (US)

(73) Assignee: Polaris Industries Inc., MN, MN (US)

(21) Appl. No.: 18/725,540

(22) PCT Filed: Dec. 28, 2022
(86) PCT No.: PCT/US2022/082491

§ 371 Date: Jun. 28, 2024

Related U.S. Application Data
(60) Provisional application No. 63/295,560, filed on Dec. 31, 2021.

(51) Int. Cl. B62M 27/02; B62J 43/16; B62J 43/28

(52) U.S. Cl. CPC B62M 27/02; B62J 43/16; B62J 43/28; B62M 2027/027; B62M 2027/028

(57) ABSTRACT

A snowmobile may have an electric powertrain. The electric powertrain may include one or more electric motors to power movement of one or more endless tracks. The electric powertrain may include a plurality of battery assemblies. At least one of the plurality of battery assemblies may be part of a structural frame of the snowmobile. At least one of the plurality of battery assemblies may be supported by a tunnel of the snowmobile.

### RELATED APPLICATIONS

The present disclosure relates to U.S. Provisional Application No. 63/295,560, filed Dec. 31, 2021, titled ELECTRIC SNOWMOBILE, the entire disclosure of which is expressly incorporated by reference herein.

### FIELD

The present disclosure relates to electric vehicles and in particular to electric vehicles with an endless track ground engaging member.

### BACKGROUND

Endless track vehicles include snowmobiles having an endless track rear ground engaging members and front skis.

### SUMMARY

In an exemplary embodiment of the present disclosure, a snowmobile is provided. The snowmobile comprising: a plurality of ground engaging members including an endless track positioned along a vertical centerline plane of the snowmobile, a left front ski, and a right front ski. The endless track being positioned rearward of the left front ski and the right front ski. The snowmobile further comprising an electric powertrain operatively coupled to the endless track to power movement of the endless track; a structural frame supported by the plurality of ground engaging members, the structural frame provides structural rigidity for the snowmobile and includes a first component of the electric powertrain; a rear suspension positioned in an interior of the endless track and movably coupled to the structural frame; a left front suspension movably coupled to the structural frame and to the left front ski; a right front suspension movably coupled to the structural frame and to the right front ski; a steering assembly supported by the structural frame and operatively coupled to the left front ski and the right front ski to steer the snowmobile, the steering assembly including an operator steering input and a steering post; and a straddle seat positioned along the vertical centerline plane of the snowmobile over the endless track and positioned longitudinally rearward of the steering post of the steering assembly.

In an example thereof, the structural frame includes a rear portion including a tunnel, a front portion positioned forward of the tunnel, and an overstructure which supports the steering assembly and extends over the front portion, the front portion being movably coupled to the left front suspension and the right front suspension.

In another example thereof, the first component is part of a battery assembly.

In a further example thereof, the battery assembly includes a battery housing and at least one battery and the first component is the battery housing of the battery assembly, the battery housing including an interior to receive the at least one battery.

In a further still example thereof, the first component is part of a motor assembly.

In yet a further example thereof, the motor assembly includes a motor housing and at least one output shaft and the first component is the motor housing.

In yet still a further example thereof, the first component forms part of the tunnel of the structural frame.

In still a further example thereof, the first component forms part of the front portion of the structural frame.

In yet another example thereof, the first component forms part of the overstructure of the structural frame.

In still another example thereof, the structural frame includes a middle portion longitudinally between the front portion and the tunnel and the first component forms part of the middle portion of the structural frame.

In another exemplary embodiment of the present disclosure, a snowmobile is provided. The snowmobile comprising a plurality of ground engaging members including an endless track positioned along a vertical centerline plane of the snowmobile, a left front ski, and a right front ski. The endless track being positioned rearward of the left front ski and the right front ski. The snowmobile further comprising an electric powertrain operatively coupled to the endless track to power movement of the endless track, the electric powertrain including at least one planetary gearset; a structural frame supported by the plurality of ground engaging members, the structural frame provides structural rigidity for the snowmobile; a rear suspension positioned in an interior of the endless track and movably coupled to the structural frame; a left front suspension movably coupled to the structural frame and to the left front ski; a right front suspension movably coupled to the structural frame and to the right front ski; a steering assembly supported by the structural frame and operatively coupled to the left front ski and the right front ski to steer the snowmobile, the steering assembly including an operator steering input and a steering post; and a straddle seat positioned along the vertical centerline plane of the snowmobile over the endless track and positioned longitudinally rearward of the steering post of the steering assembly.

In a further exemplary embodiment of the present disclosure, a snowmobile is provided. The snowmobile comprising a plurality of ground engaging members including an endless track positioned along a vertical centerline plane of the snowmobile, a left front ski, and a right front ski. The endless track being positioned rearward of the left front ski and the right front ski. The snowmobile further comprising a structural frame supported by the plurality of ground engaging members, the structural frame provides structural rigidity for the snowmobile, the structural frame including a tunnel having a forwardmost extent and an electric powertrain operatively coupled to the endless track to power movement of the endless track. The electric powertrain including an electric motor operatively coupled to the endless track and a plurality of battery assemblies operatively coupled to the electric motor, the plurality of battery assemblies including a first battery assembly supported by the tunnel and extending forward of the forwardmost extent of the tunnel.

In an example thereof, the electric powertrain further includes a continuously variable transmission, the continuously variable transmission having a drive clutch and a driven clutch operatively coupled to the drive clutch, the drive clutch being driven by the electric motor and the endless track being driven by the driven clutch.

In another example thereof, the electric powertrain further includes an electronically controlled continuously variable transmission, the electronically controlled continuously variable transmission having a drive clutch and a driven clutch operatively coupled to the drive clutch, the drive clutch being driven by the electric motor and the endless track being driven by the driven clutch.

In a further example thereof, the electric powertrain further includes a chain drive which operatively couples the electric motor to the endless track.

In yet another example thereof, the electric motor is operatively coupled to the endless track through a portion of the electric powertrain positioned laterally outboard of the first endless track.

In still another example thereof, the first battery assembly is moveable relative to the tunnel.

In yet still another example thereof, the snowmobile further comprising a mounting assembly to couple the first battery assembly to the tunnel. In a variation thereof, the mounting assembly permits a movement of the first battery assembly relative to tunnel in a longitudinal direction along the tunnel. In another variation thereof, the tunnel includes at least one track and the mounting assembly cooperates with the at least one track to limit movement of the first battery assembly in the longitudinal direction along the tunnel. In a further variation thereof, the mounting assembly includes a locked state wherein a longitudinal position of the first battery assembly is locked relative to the tunnel.

In a further yet exemplary embodiment of the present disclosure, a snowmobile is provided. The snowmobile comprising a plurality of ground engaging members including an endless track positioned along a vertical centerline plane of the snowmobile, a left front ski, and a right front ski. The endless track being positioned rearward of the left front ski and the right front ski. The snowmobile further comprising a structural frame supported by the plurality of ground engaging members, the structural frame provides structural rigidity for the snowmobile, the structural frame including a tunnel having a forwardmost extent; and an electric powertrain operatively coupled to the endless track to power movement of the endless track. The electric powertrain including an electric motor operatively coupled to the endless track; and a plurality of battery assemblies operatively coupled to the electric motor. The plurality of battery assemblies including a first battery assembly supported by the tunnel and moveable along a longitudinal direction of the tunnel while coupled to the tunnel.

In an example thereof, the snowmobile further comprising a mounting assembly to couple the first battery assembly to the tunnel. In a variation thereof, the tunnel includes at least one track and the mounting assembly cooperates with the at least one track to limit movement of the first battery assembly in the longitudinal direction along the tunnel. In another variation thereof, the mounting assembly includes a locked state wherein a longitudinal position of the first battery assembly is locked relative to the tunnel.

In a still another exemplary embodiment of the present disclosure, a snowmobile is provided. The snowmobile comprising a plurality of ground engaging members including a first endless track, a second endless track, a left front ski, and a right front ski. The first endless track and the second endless track are both positioned rearward of the left front ski and the right front ski. The snowmobile further comprising a structural frame supported by the plurality of ground engaging members, the structural frame provides structural rigidity for the snowmobile, the structural frame including a tunnel; and an electric powertrain operatively coupled to the first endless track and the second endless track to power movement of the first endless track and the second endless track. The electric powertrain including a first electric motor operatively coupled to the first endless track; a second electric motor operatively coupled to the second endless track; and a plurality of battery assemblies operatively coupled to at least one of the first electric motor and the second electric motor. The plurality of battery assemblies including a first portion and a second portion. The first portion being supported by the tunnel and the second portion being positioned forward of the tunnel.

In a yet still another exemplary embodiment of the present disclosure, a snowmobile having a longitudinal vertical centerline plane is provided. The snowmobile comprising a plurality of ground engaging members including a first endless track, a second endless track, a left front ski, and a right front ski, the first endless track and the second endless track are both positioned rearward of the left front ski and the right front ski. The first endless track having a first lateral outer extent positioned on a first side of the longitudinal vertical centerline plane. The second endless track having a second lateral outer extent positioned on a second side of the longitudinal vertical centerline plane, the second side being opposite the first side. The snowmobile further comprising a structural frame supported by the plurality of ground engaging members, the structural frame provides structural rigidity for the snowmobile, the structural frame including a tunnel; and an electric powertrain operatively coupled to the first endless track and the second endless track to power movement of the first endless track and the second endless track. The electric powertrain including a first electric motor operatively coupled to the first endless track laterally outboard of the first lateral outer extent of the first endless track; a second electric motor operatively coupled to the second endless track laterally outboard of the second lateral outer extent of the second endless track; and a plurality of battery assemblies operatively coupled to at least one of the first electric motor and the second electric motor.

In an example thereof, the plurality of battery assemblies include a first portion and a second portion, the first portion being supported by the tunnel and the second portion being positioned forward of the tunnel.

In a still further exemplary embodiment of the present disclosure, a snowmobile is provided. The snowmobile comprising a plurality of ground engaging members including an endless track positioned along a vertical centerline plane of the snowmobile, a left front ski, and a right front ski. The endless track being positioned rearward of the left front ski and the right front ski. The snowmobile further comprising a structural frame supported by the plurality of ground engaging members, the structural frame provides structural rigidity for the snowmobile; and an electric powertrain operatively coupled to the endless track to power movement of the endless track. The electric powertrain including a first electric motor operatively coupled to the endless track; a second electric motor operatively coupled to the endless track; and a plurality of battery assemblies operatively coupled to the first electric motor and the second electric motor.

In an example thereof, the plurality of battery assemblies include a first portion and a second portion, the first portion being supported by the tunnel and the second portion being positioned forward of the tunnel.

In another example thereof, an output of the first electric motor operatively coupled to the endless track is positioned on a first side of the vertical centerline longitudinal plane and an output the second electric motor operatively coupled to the endless track is positioned on a second side of the vertical centerline longitudinal plane, the second side being opposite the first side.

In a further still exemplary embodiment of the present disclosure, a method of adjusting a center of mass of a snowmobile is provided. The method comprising the steps of: supporting a first battery assembly of an electric powertrain to drive an endless track of the snowmobile to a tunnel of the snowmobile; restraining a movement of the first battery assembly relative to the tunnel to a longitudinal direction of the tunnel; moving the first battery assembly along the longitudinal direction relative to the tunnel from a first position to a second position; and locking the first battery assembly in the second position relative to the tunnel.

In yet a further still exemplary embodiment of the present disclosure, a method of selecting an operational mode from a plurality of operational modes for an electric powertrain of a snowmobile is provided. The method comprising: monitoring at least one vehicle characteristic; receiving a selected first operational mode of the plurality of operational modes; comparing the monitored vehicle characteristic to an acceptable range for the first selected mode; and if the monitored vehicle characteristic is outside of the acceptable range for the first selected mode, suggesting a second operational mode of the plurality of operational modes.

In an example thereof, the step of suggesting the second operational mode of the plurality of operational modes occurs prior to permitting the snowmobile to move by the electric powertrain. In a variation thereof, the method further comprising the steps of: displaying on a display of the snowmobile the second operational mode of the plurality of operational modes; receiving an input resulting in selecting the second operational mode of the plurality of operational modes for operation of the snowmobile; and permitting movement of the snowmobile in the second operational mode of the plurality of operational modes. In another variation thereof, the method further comprising the steps of: displaying on a display of the snowmobile the second operational mode of the plurality of operational modes; receiving an input resulting in selecting the first operational mode of the plurality of operational modes for operation of the snowmobile; and permitting movement of the snowmobile in the first operational mode of the plurality of operational modes.

In yet still a further exemplary embodiment of the present disclosure, a method of controlling a position of a tensioning wheel of an endless track assembly of a snowmobile. The method comprising: determining an operating state of the snowmobile; if the operating state of the snowmobile is a first state the tensioning wheel is positioned in a first position by an actuator; otherwise, the tensioning wheel is positioned in a second position by the actuator.

In an example thereof, the first position is a raised position relative to the second position. In a variation thereof, the operating state is a direction of travel of the snowmobile. In another variation thereof, the operating state is a direction selection of the snowmobile with an operator input.

In another still exemplary embodiment of the present disclosure, a method of controlling a position of a tensioning wheel of an endless track assembly of a snowmobile is provided. The method comprising: receive an operator request to move the tensioning wheel; determining an operating state of the snowmobile; and moving the tensioning wheel with an actuator.

In an example thereof, the actuator changes a vertical location of the tensioning wheel.

In yet another still exemplary embodiment of the present disclosure, a snowmobile is provided. The snowmobile comprising a plurality of ground engaging members including an endless track positioned along a vertical centerline plane of the snowmobile, a left front ski, and a right front ski, the endless track being positioned rearward of the left front ski and the right front ski. The endless track including a tensioning wheel and an actuator which positions the tensioning wheel. The snowmobile further comprising a structural frame supported by the plurality of ground engaging members, the structural frame provides structural rigidity for the snowmobile; an operator input supported by the structural frame; and an electronic controller operatively coupled to the operator input and the actuator, the electronic controller altering a position of the tensioning wheel with the actuator based on the operator input.

In an example thereof, the electronic controller alters a height of the tensioning wheel with the actuator based on the operator input.

In another example thereof, the snowmobile further comprising an electric powertrain operatively coupled to the endless track to power movement of the endless track. The electric powertrain including an electric motor operatively coupled to the endless track and a plurality of battery assemblies operatively coupled to the electric motor.

### BRIEF DESCRIPTION OF THE DRAWINGS

FIG. 1 illustrates a left side view of an exemplary snowmobile;

FIG. 2 illustrates a left side view of a structural frame of the snowmobile of FIG. 1;

FIG. 3 illustrates a right side view of the exemplary snowmobile of FIG. 1;

FIG. 4 illustrates a top view of the exemplary snowmobile of FIG. 1;

FIG. 5 illustrates a top view of the exemplary frame of FIG. 2;

FIG. 6 illustrates a right side view of a portion of an exemplary endless track ground engaging member with a tensioning wheel in a first position;

FIG. 7 illustrates a right side view of a portion of an exemplary endless track ground engaging member with a tensioning wheel in a second position;

FIG. 8 illustrates an exemplary processing sequence of the exemplary snowmobile of FIG. 1;

FIG. 9 illustrates another exemplary processing sequence of the exemplary snowmobile of FIG. 1;

FIG. 10 illustrates an exemplary electric powertrain assembly of the exemplary snowmobile of FIG. 1;

FIG. 11 illustrates an exemplary battery assembly of the exemplary electric powertrain assembly of FIG. 10;

FIG. 12 illustrates an exemplary motor assembly of the exemplary electric powertrain assembly of FIG. 10;

FIG. 13 illustrates exemplary placement of exemplary battery assemblies on the exemplary frame of FIG. 2;

FIG. 14 illustrates a battery assembly as part of the structural frame of the exemplary snowmobile of FIG. 1;

FIG. 15 illustrates a battery assembly as part of the structural frame of the exemplary snowmobile of FIG. 1;

FIG. 16 illustrates a motor assembly as part of the structural frame of the exemplary snowmobile of FIG. 1;

FIG. 17 illustrates an exemplary driveline of the exemplary snowmobile of FIG. 1;

FIG. 18 illustrates another exemplary driveline of the exemplary snowmobile of FIG. 1;

FIG. 19 illustrates a further exemplary driveline of the exemplary snowmobile of FIG. 1;

FIG. 20 illustrates yet another exemplary driveline of the exemplary snowmobile of FIG. 1;

FIG. 21 illustrates still a further exemplary driveline of the exemplary snowmobile of FIG. 1;

FIG. 22 illustrates an exemplary brake system of the exemplary snowmobile of FIG. 1;

FIG. 23 illustrates an exemplary placement of a power steering unit of the exemplary snowmobile of FIG. 1;

FIG. 24 illustrates another exemplary placement of a power steering unit of the exemplary snowmobile of FIG. 1;

FIG. 25 illustrates an exemplary placement of components of the exemplary snowmobile of FIG. 1;

FIG. 26 illustrates an exemplary placement of components of the exemplary snowmobile of FIG. 1 including an axial flux motor;

FIG. 27 illustrates the exemplary placement of components in FIG. 26 of the exemplary snowmobile of FIG. 1 including the axial flux motor;

FIG. 28 illustrates an exemplary placement of components of the exemplary snowmobile of FIG. 1 including a plurality of axial flux motors;

FIG. 29 illustrates an exemplary embodiment of a snowmobile including a plurality of endless tracks and a plurality of electric motors;

FIG. 30 illustrates an exemplary placement of components of the exemplary snowmobile of FIG. 1;

FIG. 31 illustrates an exemplary placement of components of the exemplary snowmobile of FIG. 1;

FIG. 32 illustrates an exemplary placement of components of an active cooling system of the exemplary snowmobile of FIG. 1;

FIG. 33 illustrates an exemplary coupling of the active cooling system of FIG. 32 with an exemplary battery assembly;

FIG. 34 illustrates an exemplary placement of components of a kinetic energy recovery system of the exemplary snowmobile of FIG. 1;

FIG. 35 illustrates a further exemplary processing sequence of the exemplary snowmobile of FIG. 1;

FIG. 36 illustrates yet another exemplary processing sequence of the exemplary snowmobile of FIG. 1;

FIG. 37 illustrates a left, front, perspective view of an exemplary layout of portions of an exemplary snowmobile;

FIG. 38 illustrates a left side view of the exemplary layout of FIG. 37;

FIG. 39 illustrates a right side view of the exemplary layout of FIG. 37;

FIG. 40 illustrates an exemplary battery assembly mounted to a tunnel of a snowmobile with a mounting assembly;

FIG. 41 is an exploded view of the mounting assembly of FIG. 40;

FIG. 42 is a cross-sectional view along lines 42-42 in FIG. 40; and

FIG. 42A is a detail view of a portion of FIG. 42.

Corresponding reference characters indicate corresponding parts throughout the several views. Unless stated otherwise the drawings are proportional with the exception of the flowcharts and block representations.

### DETAILED DESCRIPTION OF THE DRAWINGS

The embodiments disclosed below are not intended to be exhaustive or to limit the invention to the precise forms disclosed in the following detailed description. Rather, the embodiments are chosen and described so that others skilled in the art may utilize their teachings. While the present disclosure is primarily directed to a snowmobile, it should be understood that the features disclosed herein may have application to other types of vehicles such as snow bikes.

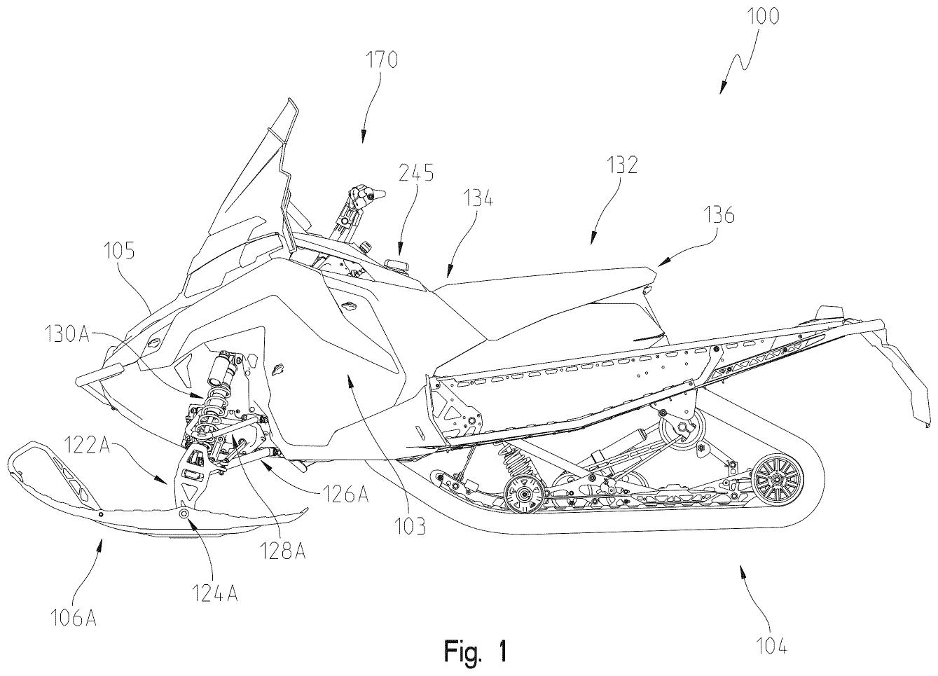

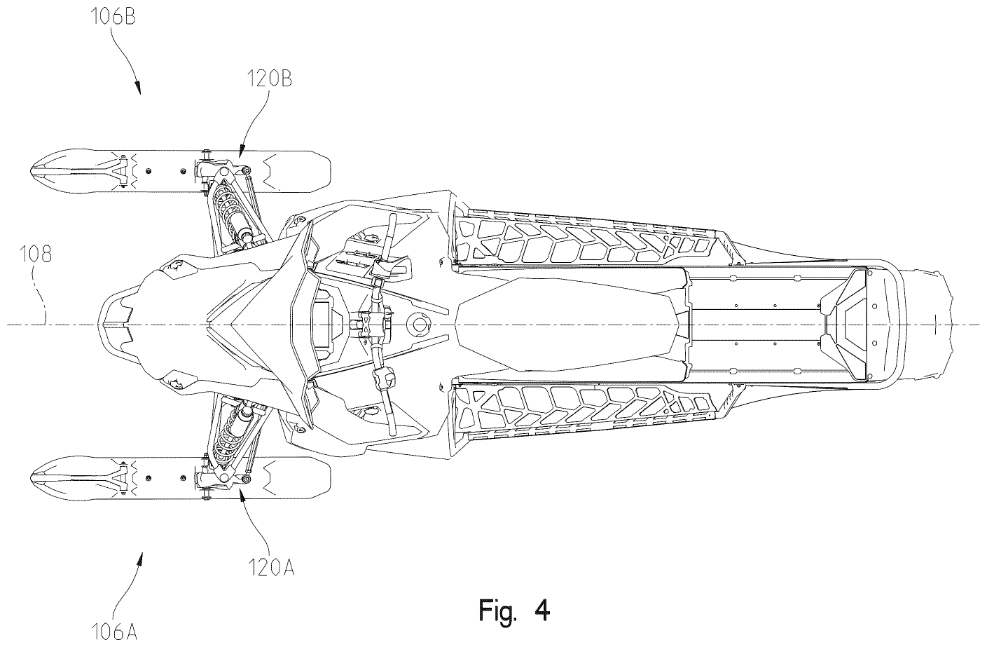

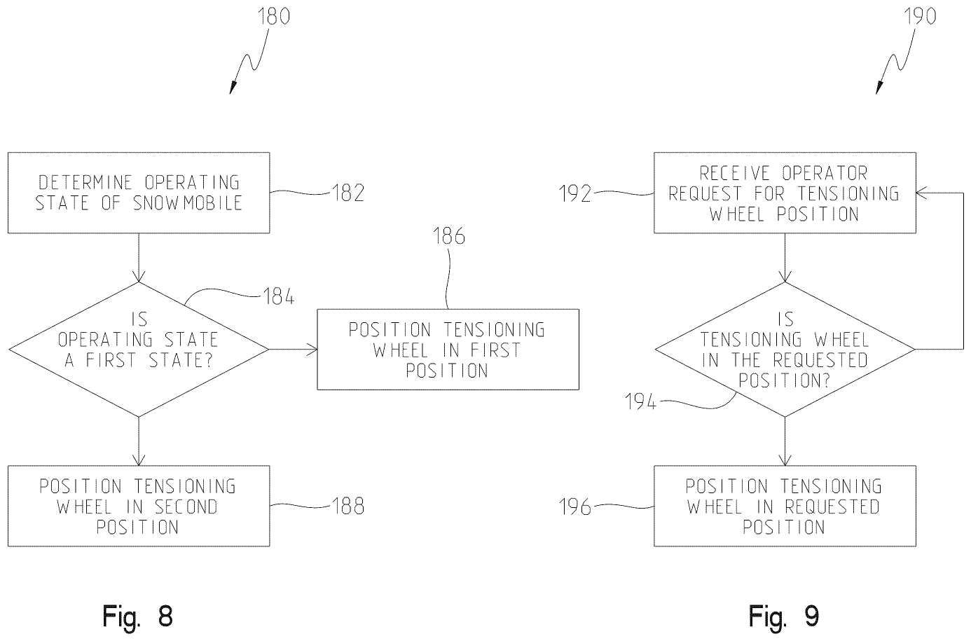

Referring to FIG. 1, an illustrated embodiment of snowmobile 100 is shown. Snowmobile 100 as illustrated includes a plurality of ground engaging members 102. Illustratively, ground engaging members 102 include an endless track assembly 104 and a pair of front skis 106A and 106B (see FIG. 4). Endless track assembly 104 supports a rear portion of snowmobile 100 while skis 106 support a front portion of snowmobile 100. Further, endless track assembly 104 is operatively coupled to an electric powertrain assembly 200 (see FIG. 8).

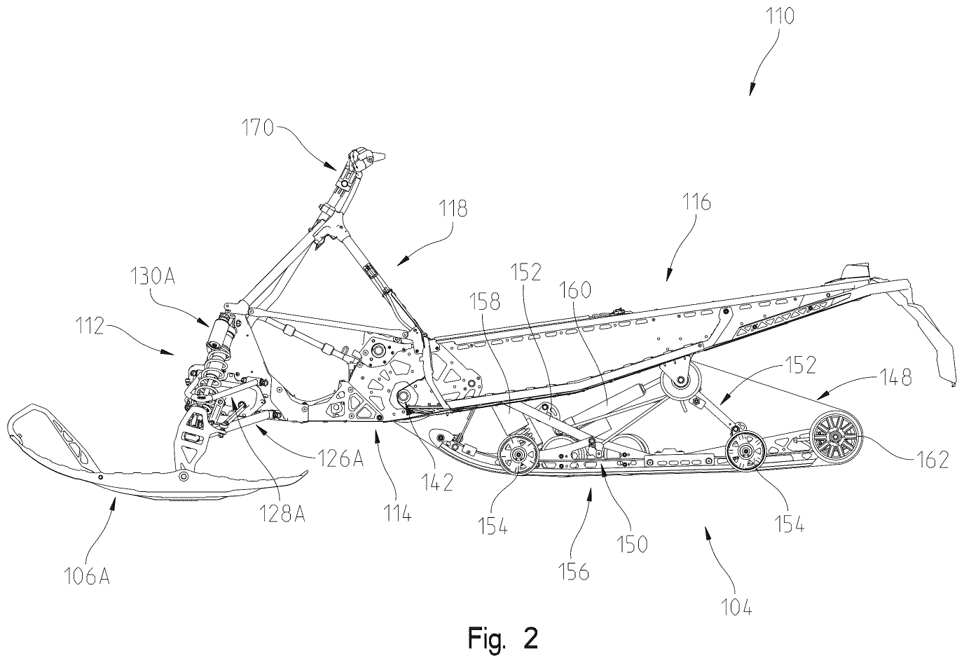

Referring to FIG. 2, snowmobile 100 includes a structural frame 110. Structural frame 110 includes a front frame portion 112 which is generally supported by skis 106. Structural frame 110 further includes a tunnel 116 which is generally supported by endless track assembly 104 and a middle frame portion 114 connecting front frame portion 112 and tunnel 116. Additionally, structural frame 110 may include an overstructure 118 which supports a steering assembly 170 of snowmobile 100. In the illustrated embodiment, front frame portion 112, middle frame portion 114, tunnel 116, and overstructure 118 are coupled together with fasteners, weldments, adhesives, or other suitable couplers. In embodiments, one or more of front frame portion 112, middle frame portion 114, tunnel 116, and overstructure 118 are integrally formed with another of front frame portion 112, middle frame portion 114, tunnel 116, and overstructure 118. Exemplary frames are disclosed in U.S. Pat. No. 8,490,731 titled SNOWMOBILE, the entire disclosure of which is expressly incorporated by reference herein.

Each of front frame portion 112, middle frame portion 114, tunnel 116, and overstructure 118 is apart of structural frame 110. Structural frame 110 provides structural rigidity for snowmobile 100. As explained herein each of front frame portion 112, middle frame portion 114, tunnel 116, overstructure 118 may support one or more portions of electric powertrain assembly 200. Further, as explained herein, one or more portions of electric powertrain assembly 200 may be part of the structural frame of snowmobile 100. For example, one or more portions of electric powertrain assembly 200 may replace a component of one or more of front frame portion 112, middle frame portion 114, tunnel 116, and overstructure 118, be interposed between the components of one or more of front frame portion 112, middle frame portion 114, tunnel 116, and overstructure 118, be interposed between two or more of front frame portion 112, middle frame portion 114, tunnel 116, and overstructure 118, and/or being integrally formed as part of one or more of front frame portion 112, middle frame portion 114, tunnel 116, and overstructure 118.

Structural frame 110 supports an operator seat 132. Operator seat 132 has a front end 134 and a rear end 136, front end 134 being positioned closer to skis 106 than rear end 136. Further, operator seat 132 is positioned rearward of a steering assembly 170 of snowmobile 100.

Front frame portion 112 is coupled to skis 106A and 106B through respective front suspensions 120A and 120B (see FIG. 4). Front suspensions 120A and 120B permits the relative movement of structural frame 110 relative to skis 106. In general, front suspension 120B is a mirror image of front suspension 120A.

Referring to FIG. 1, front suspension 120A includes a spindle 122A which is rotatably coupled to front skis 106A at a lower end. Spindle 122A is further rotatably coupled to a lower control arm 126A and an upper control arm 128A. Lower control arm 126A and upper control arm 128A are each rotatably coupled to front frame portion 112 of structural frame 110 (see FIG. 2). A shock absorber 130A is rotatably coupled to one of lower control arm 126A and upper control arm 128A and to front frame portion 112 of structural frame 110. Shock absorbers 130, in embodiments, may be electronically controlled shock absorber having adjustable compression and/or rebound damping characteristics. Additional details regarding exemplary electronically controlled shock absorber systems are described in U.S. patent application Ser. No. 17/325,062, filed May 19, 2021, titled SYSTEMS AND METHODS OF ADJUSTABLE SUSPENSIONS FOR OFF-ROAD RECREATIONAL VEHICLES, the entire disclosure of which is expressly incorporated by reference herein.

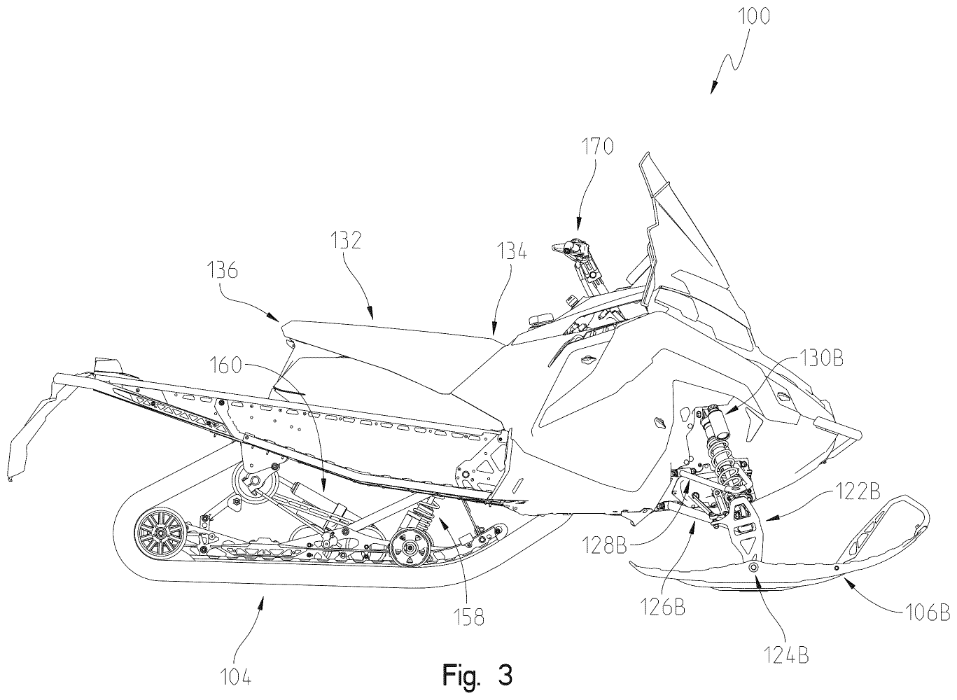

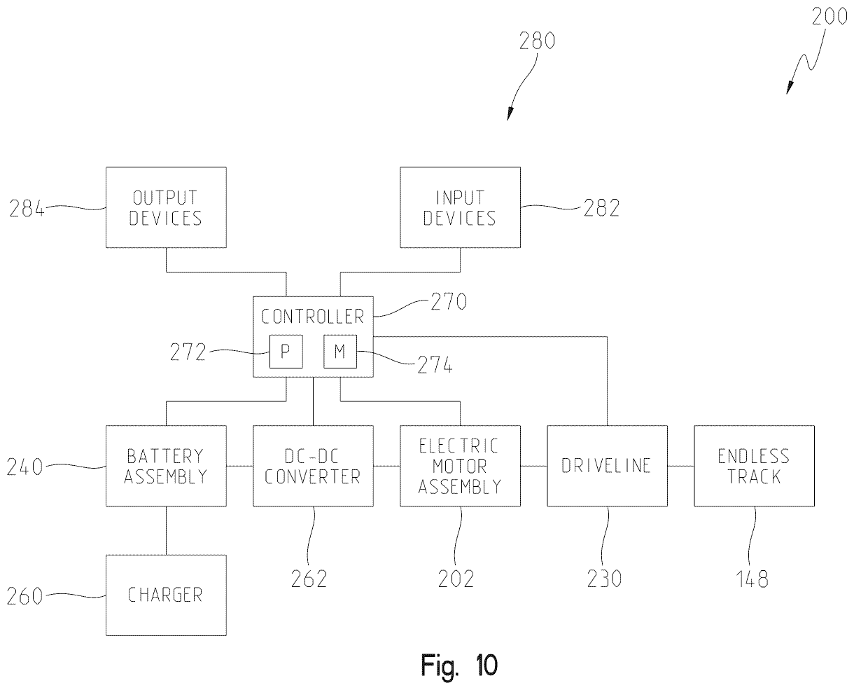

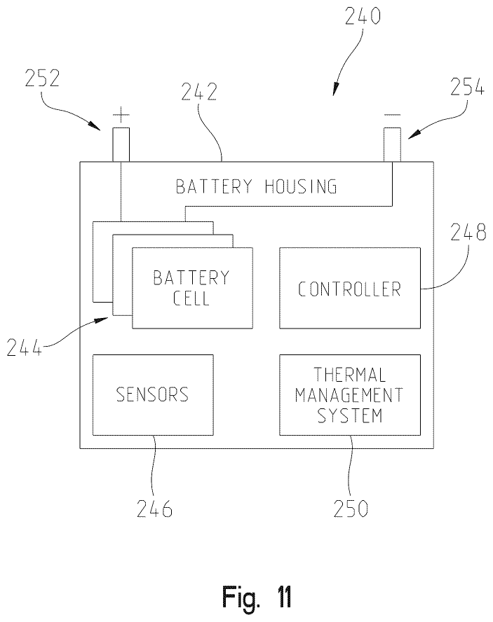

Referring to FIG. 3, structural frame 110 is supported by endless track assembly 104 through a rear suspension 140 and a drive shaft 142 (see FIG. 10). Drive shaft 142 includes at least one drive sprocket 144 which has a plurality of engagement features, such as teeth, to engage and move endless track belt 148 of endless track assembly 104. Drive shaft 142 is rotatably coupled to structural frame 110 and couples endless track assembly 104 to structural frame 110.

In the illustrated embodiment, rear suspension 140 of endless track assembly 104 includes a plurality of slide rails 150, a plurality of control arms 152 rotatably coupled to the plurality of slide rails 150 and rotatably coupled to tunnel 116 of structural frame 110, a plurality of idler wheels 154 coupled to the plurality of slide rails 150, and at least one shock absorber 156, illustratively front shock absorber 158 and rear shock absorber 160. One or both of front shock absorber 158 and rear shock absorber 160, in embodiments, may be an electronically controlled shock absorber having adjustable compression and/or rebound damping characteristics. Additional details regarding exemplary electronically controlled shock absorber systems are described in U.S. patent application Ser. No. 17/325,062, filed May 19, 2021, titled SYSTEMS AND METHODS OF ADJUSTABLE SUSPENSIONS FOR OFF-ROAD RECREATIONAL VEHICLES, the entire disclosure of which is expressly incorporated by reference herein.

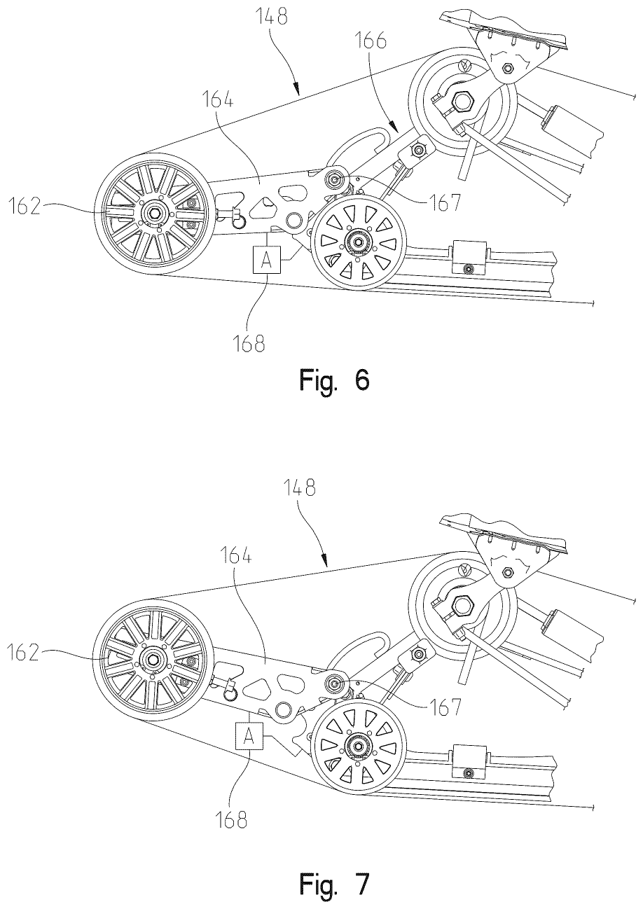

Rear suspension 140 further includes tensioning wheels 162 which are positioned at a rear portion of endless track assembly 104 and engage endless track belt 148 to control the tension on endless track belt 148. Referring to FIGS. 6 and 7, in embodiments, tensioning wheels 162 is coupled to a tensioning rail 164. Tensioning rail 164 is rotatably coupled to a rear portion 166 of endless track assembly 104 at location 167. An actuator 168 is coupled to rear portion 166 and tensioning rail 164 to control a rotation position of tensioning rail 164 relative to rear portion 166. Exemplary actuators include linear actuators, linkages, and other suitable actuators. In embodiments, actuator 168 is an electronically controlled actuator which is controlled by an electronic controller, such as controller 270 of electric powertrain assembly 200 described herein. As shown in FIG. 6, tensioning wheels 162 is shown in a lowered position. As shown in FIG. 7, tensioning wheels 162 is shown in a raised position. In embodiments, tensioning wheels 162 is placed in the lowered position when snowmobile 100 is moving relative to the ground in a forward direction wherein skis 106 are leading endless track belt 148 in the movement of snowmobile 100 and in the raised position when snowmobile 100 is moving relative to the ground in a reverse direction wherein endless track belt 148 is leading the skis 106 in the movement of snowmobile 100.

Referring to FIG. 8, an exemplary processing sequence 180 of electronic controller 270 for controlling the position of tensioning wheels 162 is shown. Electronic controller 270 determines an operating state of snowmobile 100, as represented by block 182. Exemplary operating states include a direction of travel of snowmobile 100; a direction selection of snowmobile 100 (forward or reverse) with an operator input; a speed of snowmobile 100; a selected mode of operation of snowmobile 100 (such as comfort or sport), the selected mode adjusting the characteristics of endless track assembly 104 and front suspensions 120; and other suitable states of snowmobile 100. If the operating state of snowmobile 100 is a first state then the tensioning wheel 162 is positioned in a first position, as represented by blocks 184 and 186. Otherwise, the tensioning wheel 162 is positioned in a second position, as represented by blocks 184 and 188. In embodiments, the first position of tensioning wheels 162 is the raised position of FIG. 7 and the second position of tensioning wheels 162 is the lowered position of FIG. 6.

Referring to FIG. 9, an exemplary processing sequence 190 of electronic controller 270 for controlling the position of tensioning wheels 162 is shown. Electronic controller 270 receives an operator request for tensioning wheel position, as represented by block 192. Exemplary requests may be received through an input device 282. Exemplary input devices may be specifically for tensioning wheel position or may be for other vehicle characteristic which effects the tensioning wheel position, such as forward or reverse selection. If a requested position is received, electronic controller 270 positions tensioning wheels 162 in the requested position, as represented by blocks 194 and 196.

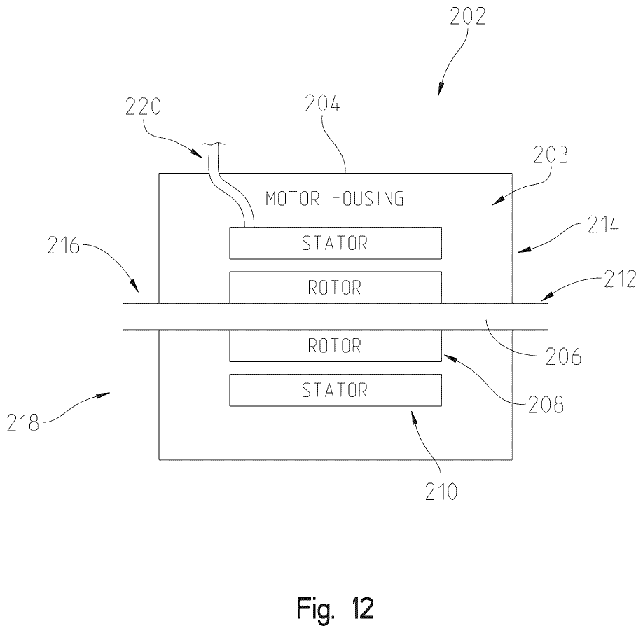

In embodiments, snowmobile 100 is powered for movement relative to the ground with an electric powertrain assembly. Referring to FIG. 10, an exemplary electric powertrain assembly 200 is shown. Electric powertrain assembly 200 includes at least one electric motor assembly 202 including an electric motor 203. Referring to FIG. 12, electric motor assembly 202 includes a motor housing 204 in which are positioned a drive shaft 206 supporting a rotor 208 and a stator 210. Drive shaft 206 includes a first end 212 which extends beyond a first end 214 of motor housing 204 and optionally a second end 216 which extends beyond a second end 218 of motor housing 204, second end 218 is opposite of first end 214. In embodiments, electric motor assembly 202 further includes an electronic controller that controls the operation of electric motor 203. Electric motor 203 receives electrical power through electrical connectors 220.

Returning to FIG. 10, electric motor assembly 202 is operatively coupled to drive sprocket 144 of endless track assembly 104 through a driveline 230. In embodiments, electric motor assembly 202 is positioned within the interior of endless track belt 148. In embodiments, electric motor assembly 202 is supported by structural frame 110 and coupled to drive shaft 142 through one or more of a gearset, a continuously variable transmission, a chain drive, other suitable coupling devices which transfer mechanical power, and/or combinations thereof.

Electric motor assembly 202 receives electrical energy from at least one battery assembly 240. In embodiments, a plurality of battery assemblies 240 are provided. Referring to FIG. 11, battery assembly 240 includes a battery housing 242 in which are positioned a plurality of battery cells 244. Exemplary battery cells may be prismatic, cylindrical, or other suitable shapes. Exemplary battery cells include lithium-ion cells, nickel-cadmium cells, and other suitable cell chemistries. Battery assembly 240 may optionally include one or more of sensors 246, an electronic controller 248, and/or a thermal management system 250.

Sensors 246 may monitor characteristics associated with one or more of battery cells 244. Exemplary characteristics include temperature, charge, current, voltage, resistance, and other suitable characteristics. Electronic controller 248 controls the operation of battery cells 244 including charging and discharging. In embodiments, battery assembly 240 includes one or more switches which electronic controller 248 controls to selectively charge at least a portion of battery cells 244 and/or selectively discharge at least a portion of battery cells 244.

Thermal management system 250 controls the temperature of battery cells 244. In embodiments, thermal management system 250 removes heat from proximate battery cells 244 to lower or reduce a rate of increase in a temperature of battery cells 244. In embodiments, thermal management system 250 provides heat to proximate battery cells 244 to raise the temperature of battery cells 244, such as during cold weather operation. Exemplary thermal management system 250 include passive systems, such as plates, heat sinks, and active systems including fluid systems to enhance removal and/or supply of heat. Exemplary active systems include air systems wherein air is directed over plates, heat sinks, or fluid conduits positioned proximate to battery cells 244 and liquid systems wherein a liquid fluid is directed through fluid conduits proximate to battery cells 244.

Plurality of battery cells 244 are electrically coupled together in series, in parallel, or in a combination of portions in series and portions in parallel. Plurality of battery cells 244 are electrically coupled to a positive terminal 252 of battery assembly 240 and a negative terminal 254 of battery assembly 240 both of which are accessible from an exterior of battery housing 242.

Battery assembly 240 may be operatively coupled to a charger 260 to charge battery cells 244. An exemplary charge port 245 (see FIG. 1) may be positioned where a gas cap would be on a gas-powered snowmobile or other suitable locations. Further, battery assembly 240 may be operatively coupled to a DC-DC converter 262 which controls the power level provided to electric motor assembly 202. In embodiments, electric motor 203 of electric motor assembly 202 is a DC motor. In embodiments, electric motor 203 of electric motor assembly 202 is an AC motor and an inverter is provided in addition to or in place of DC-DC converter 262.

In embodiments, either DC-DC converter 262 or a second DC-DC converter receives power from battery assembly 240 and is converted to either AC accessory power or DC accessory power. In embodiments, at least one plug is provided to connect accessories, such as ice augers, stereos, heaters, cooling devices, computer, and a heater for battery assembly 240.

Electric powertrain assembly 200 further includes an electronic controller 270. Electronic controller 270 includes at least one processor 272 and at least one non-transitory computer readable medium, memory 274. In embodiments, electronic controller 270 is a single unit that controls the operation of various systems of electric powertrain assembly 200 and optionally snowmobile 100. In embodiments, electronic controller 270 is a distributed system comprised of multiple controllers each of which control one or more systems of electric powertrain assembly 200 and optionally snowmobile 100 and may communicate with each other over one or more wired and/or wireless networks.

Electronic controller 270 includes logic, such as processing sequences 180, 190, 620, and 650 of FIGS. 8, 9, 35, and 36, which controls the operation of snowmobile 100. Further, memory 274 may include one or more configuration settings for electronic controller 270. The configuration settings may be used by the logic in the control of electric powertrain assembly 200 or other components and systems of snowmobile 100, such as shock absorbers 130, 158, and/or 160.

The term “logic” as used herein includes software and/or firmware executing on one or more programmable processors, application-specific integrated circuits, field-programmable gate arrays, digital signal processors, hardwired logic, or combinations thereof. Therefore, in accordance with the embodiments, various logic may be implemented in any appropriate fashion and would remain in accordance with the embodiments herein disclosed. The non-transitory machine-readable medium comprising logic can additionally be considered to be embodied within any tangible form of a computer-readable carrier, such as solid-state memory, magnetic disk, and optical disk containing an appropriate set of computer instructions and data structures that would cause a processor to carry out the techniques described herein. This disclosure contemplates other embodiments in which electronic controller 270 is not microprocessor-based, but rather is configured to control operation of propulsion system 200 based on one or more sets of hardwired instructions.

Electric powertrain assembly 200 further includes an operator interface 280 which includes a plurality of input devices 282 and a plurality of output devices 284. Exemplary input devices 282 include levers, buttons, switches, soft keys, touch screens, and other suitable input devices. Exemplary output devices 284 include lights, displays, audio devices, tactile devices, and other suitable output devices. In embodiments, operator interface 280 includes a display, such as a touch screen display, and electronic controller 270 interprets various types of touches to the touch screen display as inputs and controls the content displayed on touch screen display. In embodiments, input devices 282 includes a mode input. Mode input provides an indication to electronic controller 270 of limits, setups, and other characteristics for electric powertrain assembly 200 of snowmobile 100 and/or other components and systems of snowmobile 100

In exemplary modes, values for forward movement torque and speed performance, rearward movement torque and speed performance, and regenerative shock and/or braking performance. In one exemplary forward mode used for towing, climbing, or getting out of stuck situations, torque is maximized. In another exemplary forward mode, top speed (high endless track speed) is the focus. In a further exemplary forward economy mode, battery range is maximized. In an exemplary reverse mode, torque is maximized, and speed is limited over normal operation. An operator input may be provided, such as a button on the handlebars, to override limited speed. In a first exemplary regeneration mode, a level of regenerative braking in increased for situations like descending a hill. In this mode motor 202 provides much of the braking and capture of energy and the physical brakes would be used to supplement the motor regenerative braking. In a second exemplary regeneration mode, motor 202 provides very little freewheeling resistance and slowing snowmobile 100 down would rely solely on the physical brakes on snowmobile 100. In a third exemplary mode, a level of motor 202 regenerative braking is between the first exemplary mode and the second exemplary mode. In a fourth exemplary mode, a level of motor 202 regenerative braking is variable depending on one or more of brake lever position, brake system fluid pressure, and/or endless track speed.

In embodiments, driveline 230 includes a peak torque limiter (not shown). The peak torque limiter may be integrated as part of drive shaft 142 of endless track assembly 104, within a chaincase or transmission if included, or mounted directly to the electric motor.

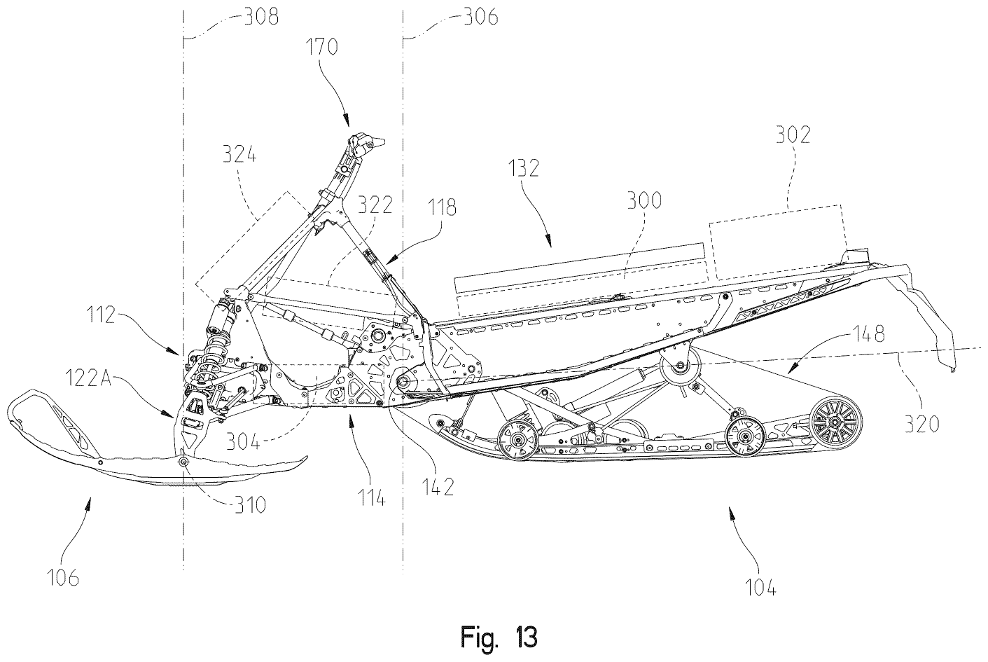

Referring to FIG. 13, exemplary layouts of battery assembly 240 on snowmobile 100 is illustrated. In embodiments, battery assembly 240 and/or other components of electric powertrain assembly 200 are placed to balance the mass of snowmobile 100 about a pitch center of snowmobile 100. In a first position 300, one or more battery assembly 240 are placed on top of tunnel 116 under operator seat 132. In a second position 302, one or more of battery assembly 240 are placed longitudinally offset from operator seat 132 and on top of tunnel 116, such as rearward of operator seat 132 as shown in FIG. 13. In a third position 304, one or more of battery assembly 240 are supported by middle frame portion 114 of structural frame 110 longitudinally forward of a vertical lateral plane 306 aligned with drive shaft 142, and optionally rearward of a vertical lateral plane 308 aligned with a pivot axis 310 between skis 106 and shock absorbers 122, and at least partially lower than a horizontal plane passing through drive shaft 142. In a fourth position 322, one or more of battery assembly 240 are supported by middle frame portion 114 of structural frame 110 longitudinally forward of vertical lateral plane 306, and optionally rearward of vertical lateral plane 308, and completely above a horizontal plane passing through drive shaft 142. In a fifth position 324, one or more of battery assembly 240 are supported by overstructure 118 of structural frame 110. In the illustrated embodiment of FIG. 13, fifth position 324 of one or more of battery assembly 240 is on a front of overstructure 118. In other embodiments, one or more of battery assembly 240 may be place on a front of overstructure 118, a back of overstructure 118, a left side of overstructure 118, a right side of overstructure 118, or a combination thereof.

In embodiments, a portion of battery assembly 240 are positioned below operator seat 132 and a heat exchanger is positioned under operator seat 132 to pull heat from the portion of battery assembly 240 to warm operator seat 132. An exemplary heat exchanger may be a cooling plate in contact with the portion of battery assembly 240 and/or other portions of electric powertrain assembly 200, such as an inverter as mentioned herein for an AC version of electric motor assembly 202.

In embodiments, at least a portion of battery assembly 240 are supported by tunnel 116 and under operator seat 132 and/or behind operator seat 132. The portion of battery assembly 240 may be swapped out or expanded to including additional battery assembly 240 to enhance the power and/or range of snowmobile 100.

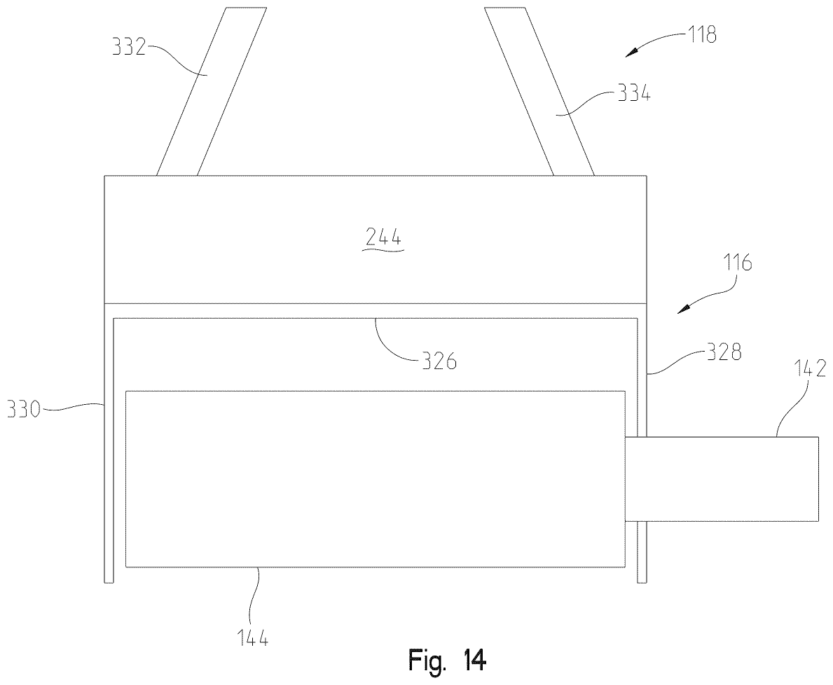

In addition to being supported by structural frame 110, in embodiments, one or more of battery assembly 240 forms part of the structural frame of snowmobile 100. Referring to FIG. 14, a battery assembly 240 is interposed between tunnel 116 and overstructure 118 and each of tunnel 116 and overstructure 118 are connected thereto. Tunnel 116 includes an inverted U-shape having a top 326, a right side wall 328, and a left side wall 330. Drive sprocket 144 extends between left side wall 330 and right side wall 328 and drive shaft 142 extends from inside tunnel 116 to outside of tunnel 116. Battery assembly 240 is mounted to top 326 of tunnel 116 and a left rear support 332 and a right rear support 334 of overstructure 118 are mounted to battery assembly 240. In embodiments, one or more of battery cells 244 may be interposed between any two of front frame portion 112, middle frame portion 114, tunnel 116, and overstructure 118. In embodiments, one or more battery cells 244 replace one or more of front frame portion 112, middle frame portion 114, tunnel 116, and overstructure 118.

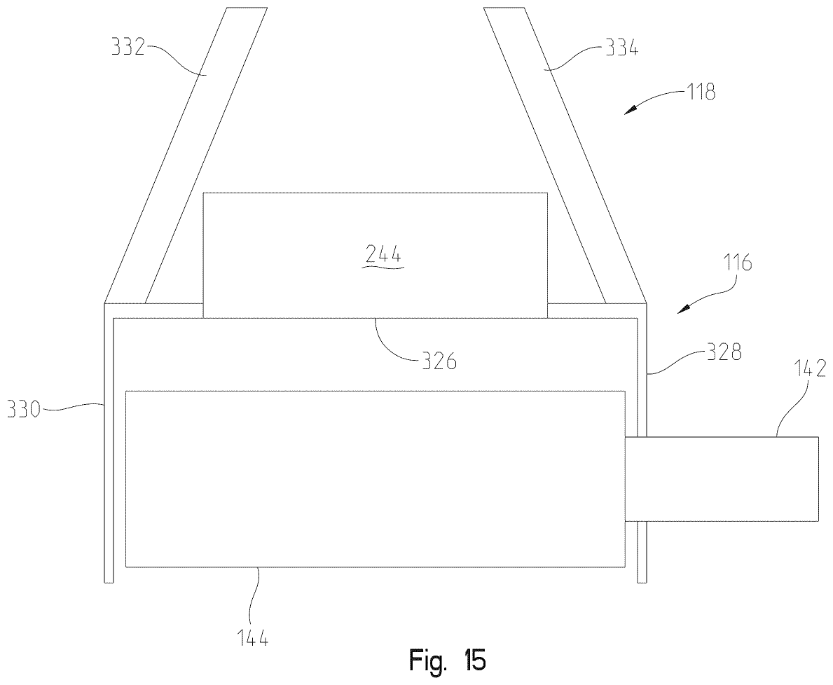

In embodiments, battery assembly 240 forms part of the structural frame of snowmobile 100. A battery assembly 240 forms part of one or more of front frame portion 112, middle frame portion 114, tunnel 116, and overstructure 118. For example, referring to FIG. 15, a battery assembly 240 forms part of top 326 of tunnel 116 and overstructure 118 connects to tunnel 116 independent of battery assembly 240. In embodiments, overstructure 118 connects to tunnel 116 through battery assembly 240 and battery assembly 240 both forms part of tunnel 116, and optionally part of overstructure 118, and is interposed between tunnel 116 and overstructure 118. In embodiments, battery assembly 240 replaces middle frame portion 114 and front frame portion 112 as part of the structural frame 110. The front suspensions 120 may be bolted or otherwise fastened to a front portion of battery assembly 240 and the front of tunnel 116 may be fastened to a rear portion of battery assembly 240. In embodiments, suspension components, such as lower control arms 126, upper control arms 128, shock absorbers 130, and sway bars may be coupled to the front portion of battery assembly 240. One or more additional battery assemblies 240 may for part of the structural frame of the tunnel 116 such as the top portion of the tunnel and the sides, front, and/or rear of the tunnel 116 may be fastened to the battery assembly 240 forming the top of tunnel 116. Additionally portions of overstructure 118 may be formed by one or more battery assemblies 240. The steering post, mounts for the hood, and other components could be mounted to the one or more battery assemblies, such as to bosses or recesses provided on the one or more battery assemblies. In embodiments, both the upper and lower steering shafts may be the one or more battery assemblies. The one or more battery assemblies may be positioned to provide proper clearance for the drag link connecting the upper and lower steering shafts to provide full range of steering motion. An advantage, among others, of having at least one or more battery assemblies form part of the structural frame is a reduction in the weight of vehicle 100.

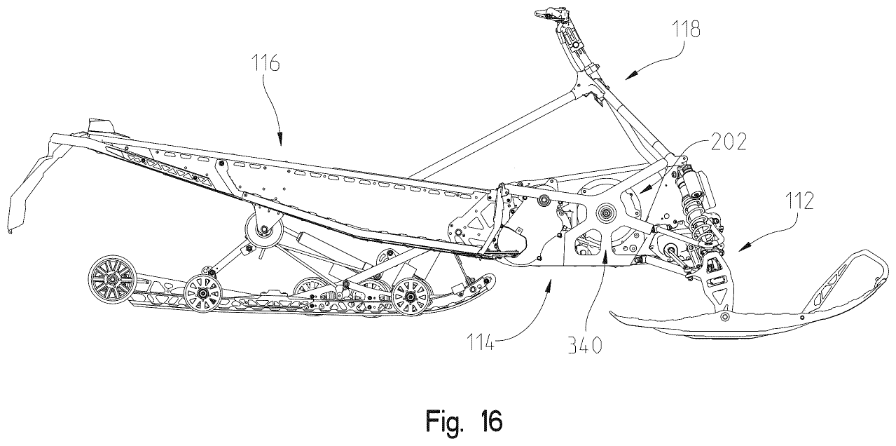

Similar to battery assembly 240, electric motor assembly 202 may be part of structural frame 110. Electric motor assembly 202 may be interposed between any two of front frame portion 112, middle frame portion 114, tunnel 116, and overstructure 118, forms part of at least one of front frame portion 112, middle frame portion 114, tunnel 116, and overstructure 118, and both is interposed between any two of front frame portion 112, middle frame portion 114, tunnel 116, and overstructure 118 and forms part of at least one of front frame portion 112, middle frame portion 114, tunnel 116, and overstructure 118. Referring to FIG. 16, a bracket 340 of electric motor assembly 202 is coupled to motor housing 204 and electric motor assembly 202 forms a right side part of middle frame portion 114 of structural frame 110.

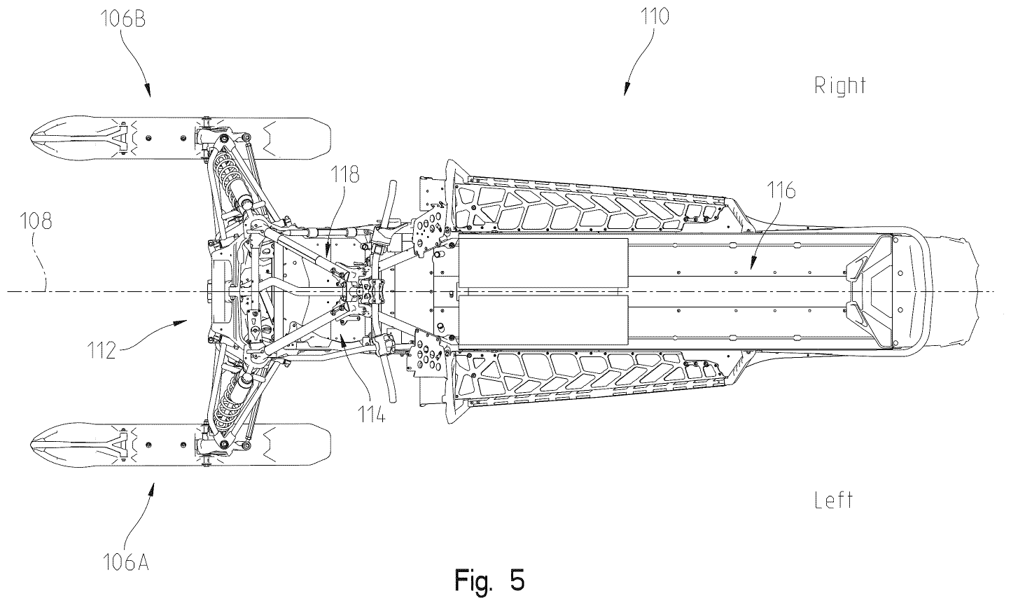

Further, similar to battery assembly 240, the placement of electric motor assembly 202 on snowmobile 100 supported by one or more of front frame portion 112, middle frame portion 114, tunnel 116, and overstructure 118. In embodiments, electric motor assembly 202 is placed forward of vertical lateral plane 306. In embodiments, electric motor assembly 202 is placed forward of vertical lateral plane 306 and predominantly to one side, left or right, of a longitudinal vertical plane 108 (see FIG. 5) of snowmobile 100, and optionally completely to one side, left or right of longitudinal vertical plane 108 of snowmobile 100. In embodiments, electric motor assembly 202 is placed forward of vertical lateral plane 306 and is centered relative to longitudinal vertical plane 108 of snowmobile 100. In embodiments, a first electric motor assembly 202 is placed forward of vertical lateral plane 306 and predominantly to one side, left or right, of longitudinal vertical plane 108 of snowmobile 100, and optionally completely to one side, left or right of longitudinal vertical plane 108 of snowmobile 100 and a second electric motor assembly 202 is placed forward of vertical lateral plane 306 and predominantly to the other side, left or right, of longitudinal vertical plane 108 of snowmobile 100, and optionally completely to one side, left or right of longitudinal vertical plane 108 of snowmobile 100. An advantage, among others, of having at least one of electric motor assembly 202 and/or at least one of battery assembly 240 be part of structural frame 110 is the reduction in weight of snowmobile 100.

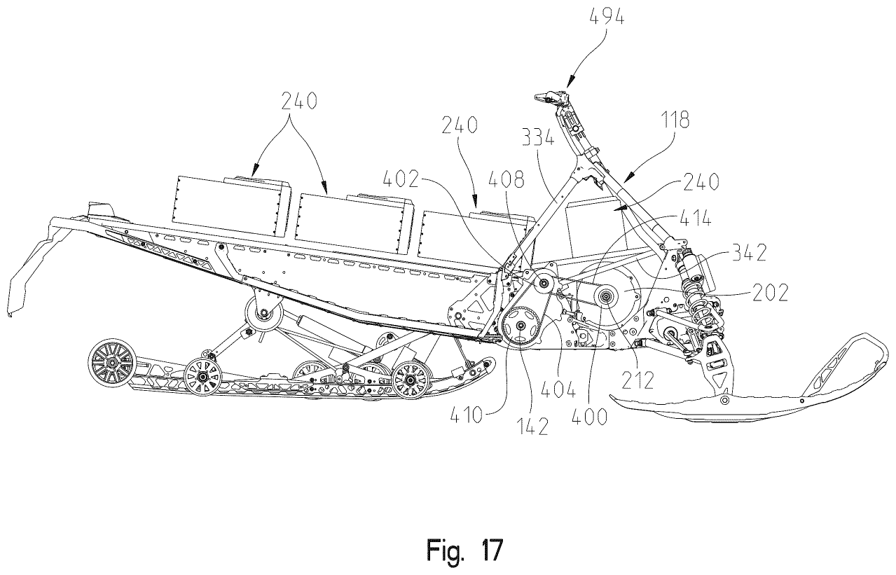

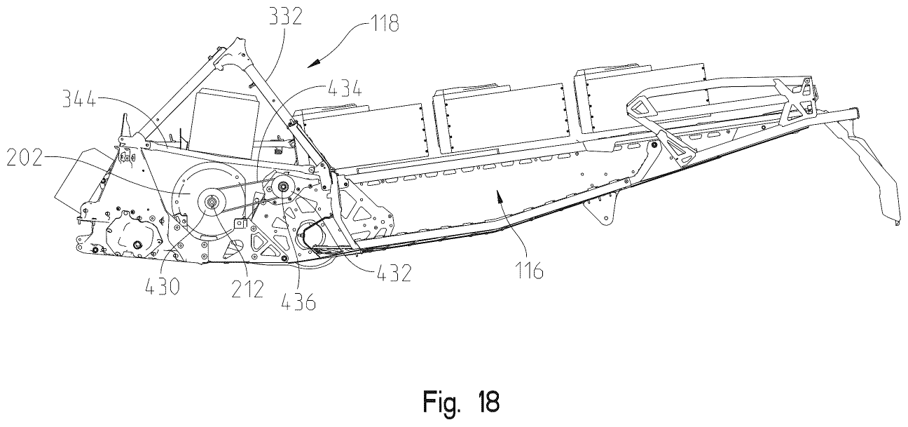

Referring to FIG. 17, an exemplary embodiment of driveline 230 is shown. In FIG. 17, electric motor assembly 202 is positioned so that output shaft 212 of electric motor assembly 202 or a rotatable shaft operatively coupled to output shaft 212 extends outboard of tunnel 116 and overstructure 118 of structural frame 110, in particular support 342 of overstructure 118. Driveline 230 includes a drive wheel 400 coupled to first end 212 of drive shaft 206 of electric motor assembly 202, a driven wheel 402, and an endless connector 404 operatively coupling driven wheel 402 to drive wheel 400. In embodiments, endless connector 404 is a belt and each of drive wheel 400 and driven wheel 402 are pulleys adapted for use with a belt. In embodiments, endless connector 404 is a chain and each of drive wheel 400 and driven wheel 402 are sprockets adapted for use with a chain.

Driven wheel 402 is carried by a rotatable shaft 408 on which a second drive wheel (not shown) is also carried and rotates with driven wheel 402. The second drive wheel, or another rotatable element operatively coupled to the second drive wheel, is operatively coupled to a second driven wheel 410 through a second endless connector 414. Second driven wheel 410 is carried by drive shaft 142. In embodiments, second endless connector 414 is a belt and each of second drive wheel and second driven wheel 410 are pulleys adapted for use with a belt. In embodiments, second endless connector 414 is a chain and each of second drive wheel and second driven wheel 410 are sprockets adapted for use with a chain.

A rotation of first end 212 of drive shaft 206 causes a corresponding rotation of drive wheel 400 which rotates driven wheel 402 through endless connector 404. Driven wheel 402 in turn causes a rotation of drive shaft 142 through the second drive wheel, second endless connector 414, and second driven wheel 410. In embodiments, the second drive wheel, second driven wheel 410, and second endless connector 414 are provided in a chaincase having fluid to lubricate second endless connector 414 and the rotatable shaft connected to the second drive wheel and driven wheel 402 extends outward from the chaincase to support driven wheel 402.

Referring to FIG. 18, another exemplary embodiment of driveline 230 is shown. In FIG. 18, electric motor assembly 202 is positioned so that output shaft 212 of electric motor assembly 202 or a rotatable shaft operatively coupled to output shaft 212 extends outboard of tunnel 116, and optionally of overstructure 118, in particular support 344 of overstructure 118. Driveline 230 includes a drive wheel 430 coupled to first end 212 of drive shaft 206 of electric motor assembly 202, a driven wheel 432, and an endless connector 434 operatively coupling driven wheel 432 to drive wheel 430. In embodiments, endless connector 434 is a belt and each of drive wheel 430 and driven wheel 432 are pulleys adapted for use with a belt. In embodiments, endless connector 434 is a chain and each of drive wheel 430 and driven wheel 432 are sprockets adapted for use with a chain.

Driven wheel 402 is carried by a rotatable jackshaft 436 on a left side of tunnel 116. Jackshaft 436 extends across longitudinal vertical plane 108 and extends beyond tunnel 116 on a right side of snowmobile 100. Jackshaft 436 is received on the right side of tunnel 116 in a chaincase (not shown) which transfer the rotation of rotatable jackshaft 436 to drive shaft 142.

A rotation of first end 212 of drive shaft 206 causes a corresponding rotation of drive wheel 430 which rotates driven wheel 432 through endless connector 434. Driven wheel 432 in turn causes a rotation of rotatable jackshaft 436 which, in turn, causes a rotation of drive shaft 142 through the chaincase.

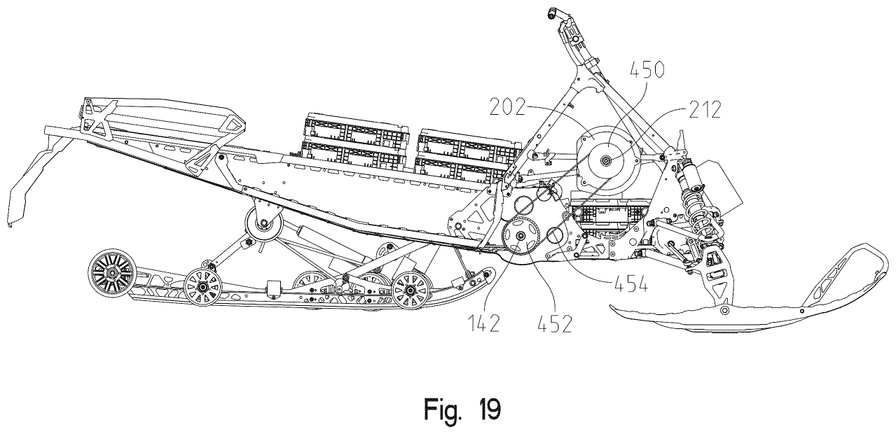

Referring to FIG. 19, yet another exemplary embodiment of driveline 230 is shown. In FIG. 19, electric motor assembly 202 is positioned so that output shaft 212 of electric motor assembly 202 or a rotatable shaft operatively coupled to output shaft 212 extends outboard of tunnel 116, and optionally of overstructure 118. Driveline 230 includes a drive wheel 450 coupled to first end 212 of drive shaft 206 of electric motor assembly 202, a driven wheel 452, and an endless connector 454 operatively coupling driven wheel 452 to drive wheel 450. In embodiments, endless connector 454 is a belt and each of drive wheel 450 and driven wheel 452 are pulleys adapted for use with a belt. In embodiments, endless connector 454 is a chain and each of drive wheel 450 and driven wheel 452 are sprockets adapted for use with a chain. Driven wheel 402 is carried by drive shaft 142.

A rotation of first end 212 of drive shaft 206 causes a corresponding rotation of drive wheel 450 which rotates driven wheel 452 through endless connector 454. Driven wheel 452 in turn causes a rotation of drive shaft 142.

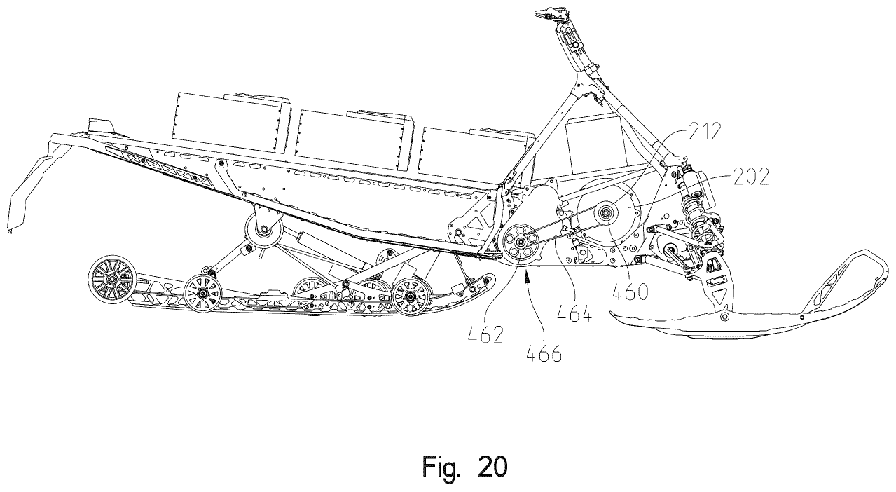

Referring to FIG. 20, a further exemplary embodiment of driveline 230 is shown. In FIG. 20, electric motor assembly 202 is positioned so that output shaft 212 of electric motor assembly 202 or a rotatable shaft operatively coupled to output shaft 212 extends outboard of tunnel 116 and overstructure 118 of structural frame 110. Driveline 230 includes a drive wheel 460 coupled to first end 212 of drive shaft 206 of electric motor assembly 202, a driven wheel 462, and an endless connector 464 operatively coupling driven wheel 462 to drive wheel 460. In embodiments, endless connector 464 is a belt and each of drive wheel 460 and driven wheel 462 are pulleys adapted for use with a belt. In embodiments, endless connector 464 is a chain and each of drive wheel 460 and driven wheel 462 are sprockets adapted for use with a chain.

Driven wheel 462 is coupled to an input gear (not shown) of a gearset 466 and is operatively coupled to drive shaft 142 through gearset 466. Exemplary gearsets 466 include planetary gearsets 408. In embodiments, driven wheel 402 is coupled to one of a sun gear, a planet carrier, and/or a ring gear of gearset 466. In embodiments, gearset 466 includes multiple planetary gearsets and one or more of selective couplers, brakes or clutches, which may be selectively activated by electronic controller 270 to select a gear ratio between drive shaft 142 and the input gear coupled to driven wheel 462.

A rotation of first end 212 of drive shaft 206 causes a corresponding rotation of drive wheel 460 which rotates driven wheel 462 through endless connector 464. Driven wheel 462 in turn causes a rotation of drive shaft 142 through gearset 466.

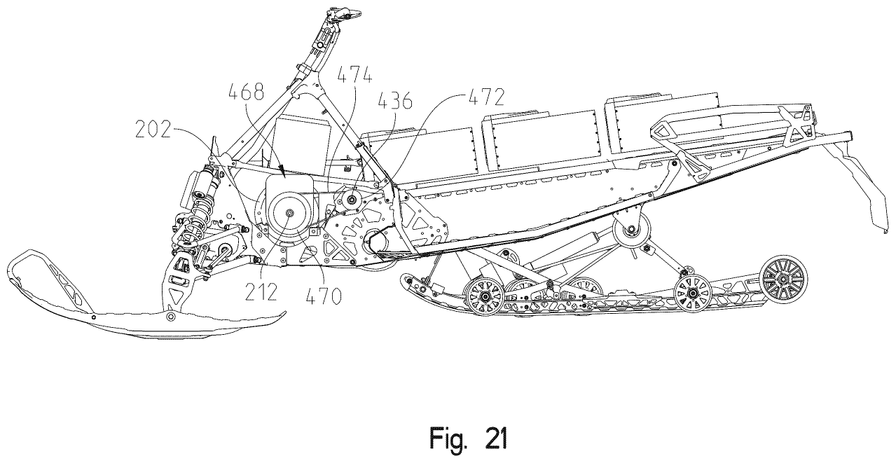

Referring to FIG. 21, a yet further exemplary embodiment of driveline 230 is shown. In FIG. 21, electric motor assembly 202 is positioned so that output shaft 212 of electric motor assembly 202 or a rotatable shaft operatively coupled to output shaft 212 extends outboard of tunnel 116, and optionally of overstructure 118. Driveline 230 includes a continuously variable transmission (CVT) 468 which includes a drive clutch 470 coupled to first end 212 of drive shaft 206 of electric motor assembly 202, a driven clutch 472, and an endless connector 474 operatively coupling driven clutch 472 to drive clutch 470. In embodiments, endless connector 474 is a belt and each of drive clutch 470 and driven clutch 472 includes two sheaves whose spacing controls the gear ratio of CVT 468. In embodiments, CVT 468 is solely mechanically controlled. In embodiments, CVT 468 is at least partially electronically controlled by electronic controller 270. Exemplary CVT arrangements are disclosed in U.S. Pat. No. 8,490,731 titled SNOWMOBILE; U.S. Pat. No. 8,534,413 titled PRIMARY CLUTCH ELECTRONIC CVT; U.S. Pat. No. 9,540,072 titled SNOWMOBILE; and U.S. Pat. No. 10,648,554 titled SNOWMOBILE, the entire disclosures of which are expressly incorporated by reference herein.

Driven clutch 472 is carried by a rotatable jackshaft 436 on a left side of tunnel 116. Jackshaft 436 extends across longitudinal vertical plane 108 and extends beyond tunnel 116 on a right side of snowmobile 100. Jackshaft 436 is received on the right side of tunnel 116 in a chaincase (not shown) which transfer the rotation of rotatable jackshaft 436 to drive shaft 142.

A rotation of first end 212 of drive shaft 206 causes a corresponding rotation of drive clutch 470 which rotates driven clutch 472 through endless connector 474. Driven clutch 472 in turn causes a rotation of rotatable jackshaft 436 which, in turn, causes a rotation of drive shaft 142 through the chaincase.

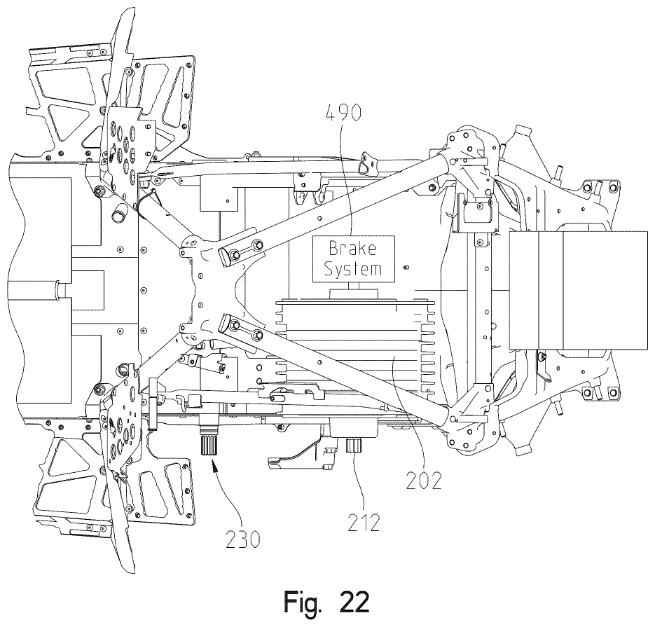

Referring to FIG. 22, an exemplary brake system 490 is shown. Brake system 490 is coupled to second end 216 on side 218 of motor housing 204 opposite first end 212 of drive shaft 206 which is coupled to driveline 230. Brake system 490 may include a brake disk coupled to second end 216 of drive shaft 206 and a brake caliper which is actuated to apply braking force to the brake disk and thereby to endless track assembly 104 through driveline 230 and electric motor assembly 202. In embodiments, the actuation of the brake caliper is controlled by electronic controller 270. In embodiments, the actuation of the brake caliper is controlled with a fluid system. In either case, the actuation is initiated by the operator actuating a brake input, such as a brake lever on handlebars 494.

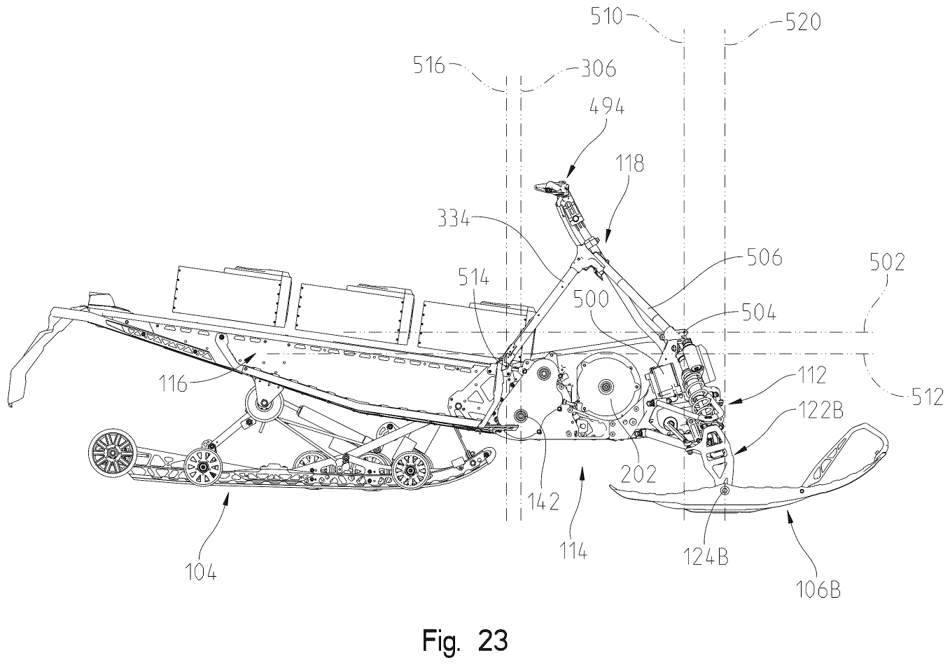

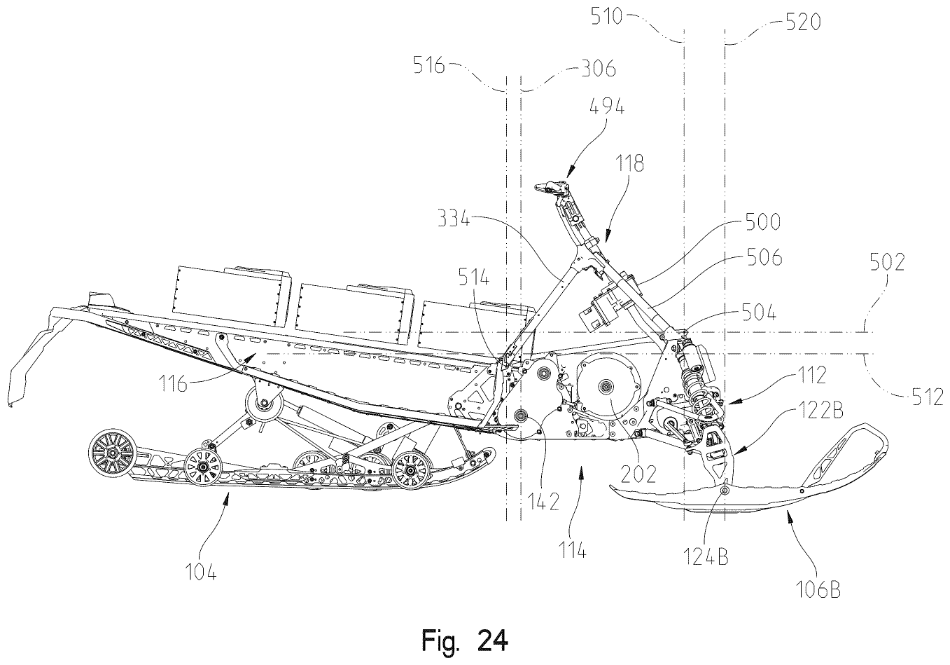

Referring to FIGS. 23 and 24, exemplary placements of a power steering unit 500 are illustrated. Referring to FIG. 23, a first horizontal plane 502 passes through a connection 504 between a front support 506 of overstructure 118 of structural frame 110 and front frame portion 112 of structural frame 110 and a first lateral vertical plane 510 also passes through connection 504. A second horizontal plane 512 passes through a connection 514 between rear support 334 of overstructure 118 of structural frame 110 and tunnel 116 of structural frame 110 and a second lateral vertical plane 516 also passes through connection 514. A third lateral vertical plane 520 passes through a connection 124 between ski 106 and spindle 122. As shown in FIG. 23, a first placement of power steering unit 500 is positioned between third lateral vertical plane 520 and second lateral vertical plane 516 along a longitudinal length of snowmobile 100. Power steering unit 500 is also shown being positioned within overstructure 118 and lower than first horizontal plane 502. As shown in FIG. 24, a second placement of power steering unit 500 is positioned between third lateral vertical plane 520 and second lateral vertical plane 516 along a longitudinal length of snowmobile 100. Power steering unit 500 is also shown being positioned higher than second horizontal plane 512 and optionally higher than 502. Power steering unit 500 is also shown being positioned completely higher than electric motor assembly 202. In embodiments, power steering unit 500 straddles one of first horizontal plane 502 and second horizontal plane 512.

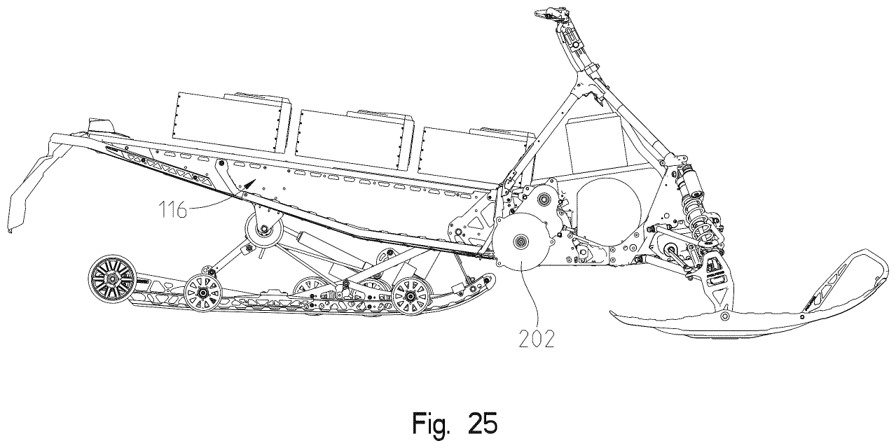

Referring to FIG. 25, in embodiments, electric motor assembly 202 may be positioned within tunnel 116 or longitudinally adjacent to tunnel 116. An advantage, among others of this placement of electric motor assembly 202 includes the provision of additional space below overstructure 118 for battery assembly 240 or storage.

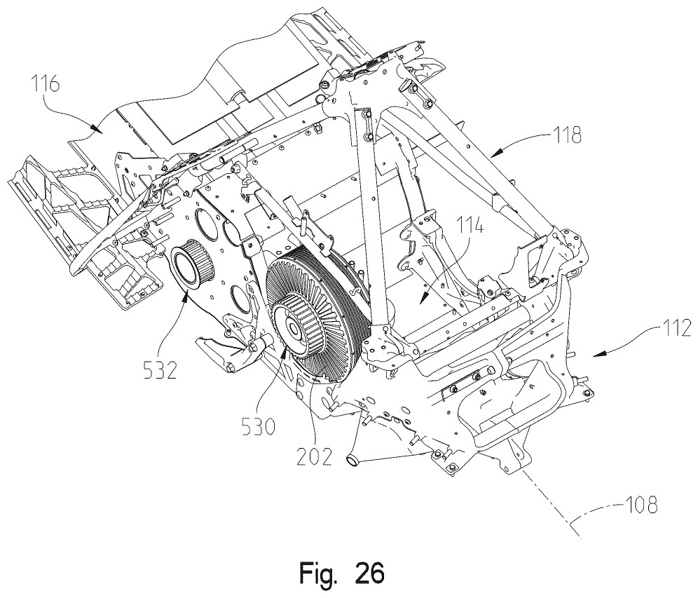

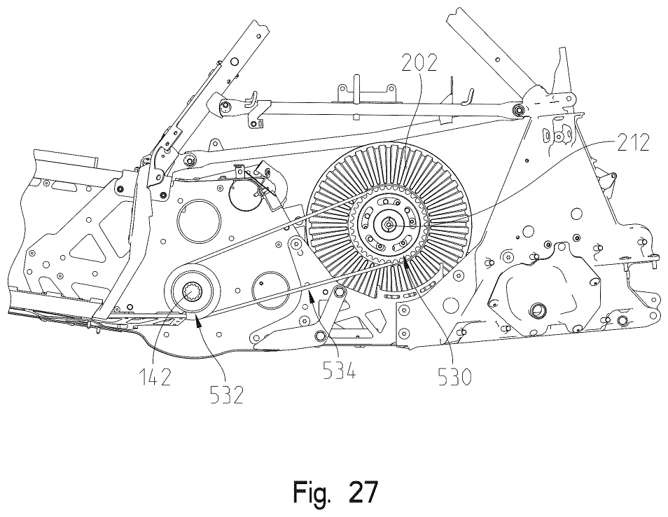

Referring to FIGS. 26 and 27, electric motor assembly 202 is shown positioned completely to the right side of longitudinal vertical plane 108 (see FIG. 26). In the illustrated embodiment, electric motor assembly 202 includes an axial flux motor which has a narrow lateral extent. Other exemplary motors sized and/or mounted to be positioned completely to the right side of longitudinal vertical plane 108 may be used. Advantages, among others, for using an axial flux motor are space savings, additional space for batteries and/or storage, and power density capabilities. As shown in FIG. 27, first end 212 of drive shaft 206 carries a first wheel 530. First wheel 530 is operatively coupled to drive shaft 142 through a second wheel 532 carried by drive shaft 142 through an endless connector 534. In embodiments, endless connector 534 is a belt and each of drive wheel 530 and driven wheel 532 are pulleys adapted for use with a belt. In embodiments, endless connector 534 is a chain and each of drive wheel 530 and driven wheel 532 are sprockets adapted for use with a chain.

A rotation of first end 212 of drive shaft 206 causes a corresponding rotation of drive wheel 530 which rotates driven wheel 532 through endless connector 534. Driven wheel 532 in turn causes a rotation of drive shaft 142. In embodiments, the axial flux motor may be used with any of the embodiments of driveline 230 disclosed herein.

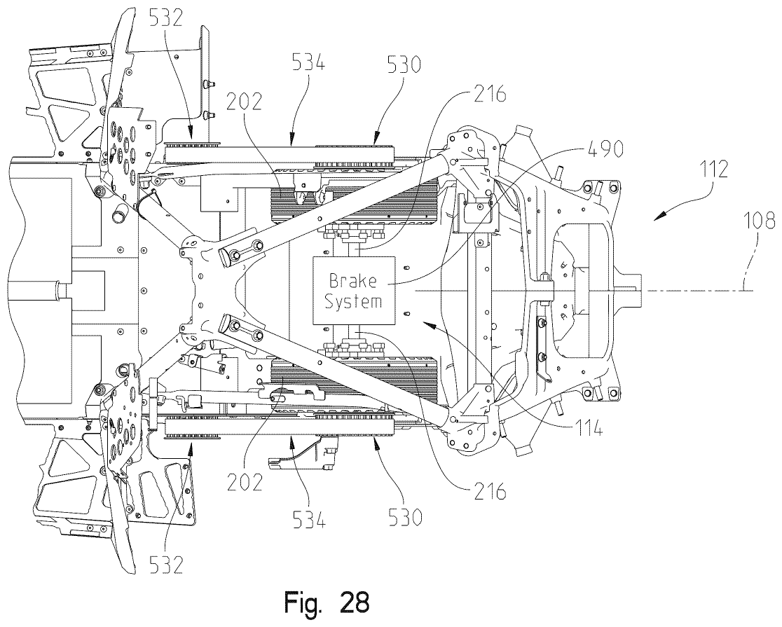

Referring to FIG. 28, an exemplary layout having two electric motor assemblies 202 is illustrated. Each of the electric motor assemblies 202 are axial flux motors and are coupled independently to drive shaft 142 through respective first wheel 530, second wheel 532, and endless connector 534. Each electric motor assembly is positioned completely to a respective side of longitudinal vertical plane 108. Brake system 490 is coupled to second end 216 of each of the electric motor assemblies. In embodiments, exemplary brake system 490 includes separate brake disks and calipers for each respective second end 216 of drive shaft 206. In embodiments, the brake system 490 may be on first end 212 of driveshaft 206 or on the shaft supporting second wheel 532.

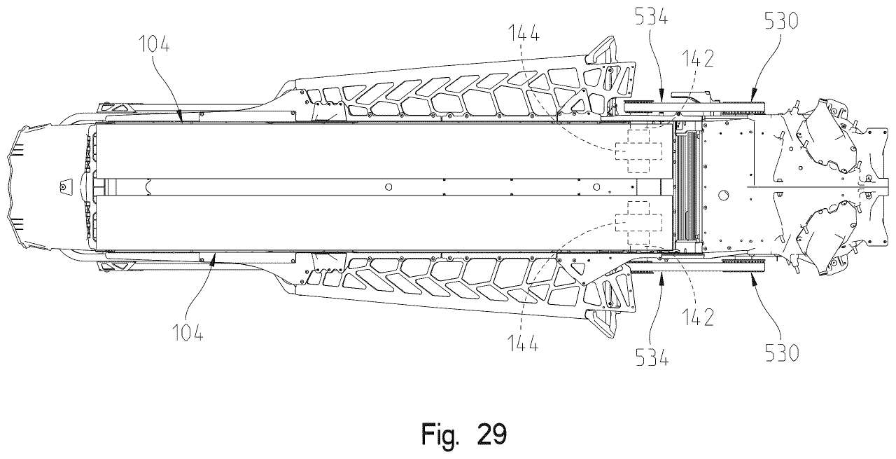

Referring to FIG. 29, the arrangement of FIG. 28 is illustrated except each of electric motor assemblies 202 drives an independent drive shaft 142 and an independent endless track assembly 104. By having multiple endless tracks, the track speed and direction of each may be individually controlled by electronic controller 270. In embodiments, electronic controller 270 may differentiate the track speeds to assist in turning of snowmobile 100 based in part on a sensed turn angle of handlebars by the operator. In embodiments, electronic controller 270 may cause snowmobile 100 to spin in place by rotating the respective tracks 104 in opposite directions.

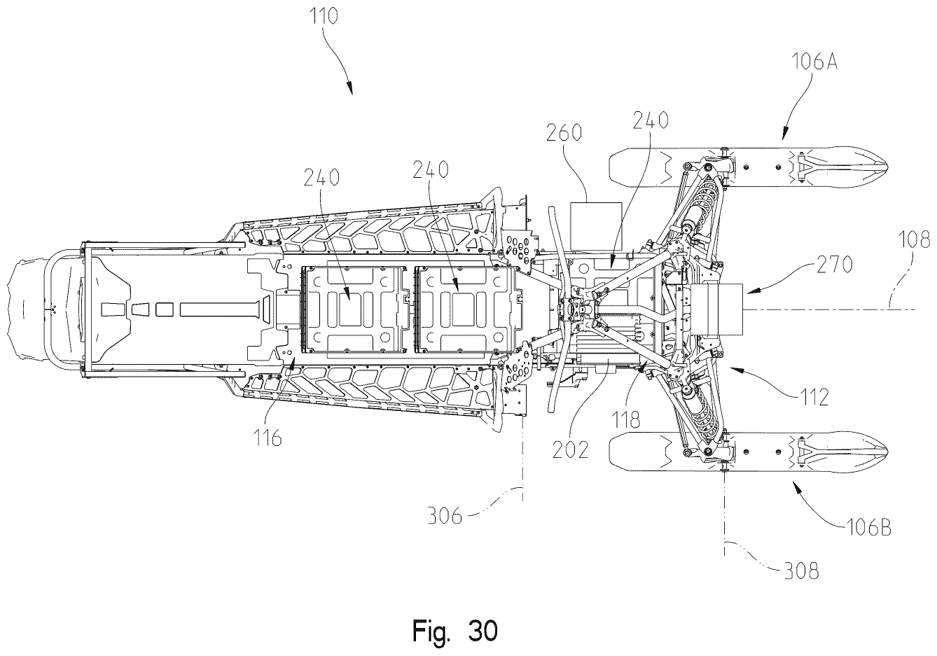

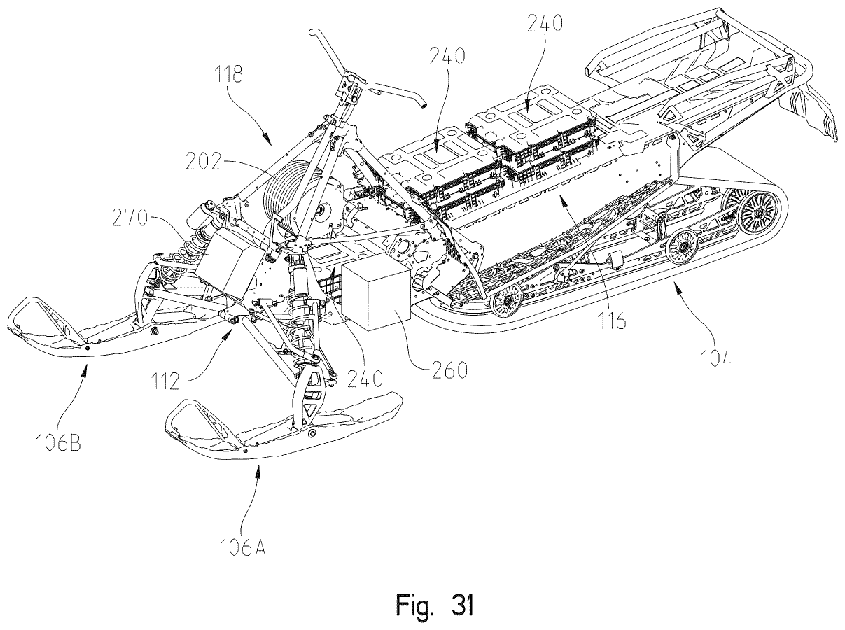

Referring to FIGS. 30 and 31, an exemplary layout of some components of electric powertrain assembly 200 for snowmobile 100 are shown. As shown in FIG. 30, battery assemblies 240 have a first portion positioned longitudinally between vertical lateral plane 306 and vertical lateral plane 308 and a second portion positioned longitudinally rearward of vertical lateral plane 306.

A single electric motor assembly 202 is positioned longitudinally between vertical lateral plane 306 and vertical lateral plane 308 and above the first portion of battery assemblies 240. As illustrated electric motor assembly 202 is positioned on both sides of longitudinal vertical plane 108. In embodiments, electric motor assembly 202 is centered about longitudinal vertical plane 108. In embodiments, electric motor assembly 202 is completely to one side of longitudinal vertical plane 108.

In embodiments, the first portion of battery assemblies 240 is positioned completely above electric motor assembly 202. In embodiments, the first portion of battery assemblies 240 is positioned both above electric motor assembly 202 and below electric motor assembly 202. In embodiments, the first portion of battery assemblies 240 may be positioned laterally offset from electric motor assembly 202 such that electric motor assembly 202 is completely to one side laterally of the first portion of battery assemblies 240.

Charger 260 is positioned longitudinally between vertical lateral plane 306 and vertical lateral plane 308. Further, charger 260 is positioned on a first side of longitudinal vertical plane 108 and at least a majority of electric motor assembly 202 is positioned on a second side of longitudinal vertical plane 108 opposite the first side. In embodiments, charger 260 is positioned completely to a first side of longitudinal vertical plane 108 and electric motor assembly 202 is positioned completely to a second side of longitudinal vertical plane 108. In embodiments, charger 260 is mounted to overstructure 118. Charger 260 is illustrated on a left side of longitudinal vertical centerline plane 108. In embodiments, charger 260 is positioned longitudinally between vertical lateral plane 306 and vertical lateral plane 308 and on a right side of longitudinal vertical centerline plane 108. In embodiment, charger 260 is positioned on tunnel 116 and may be positioned forward of operator seat 132 and/or above one or more of battery assembly 240 which may also be supported on tunnel 116.

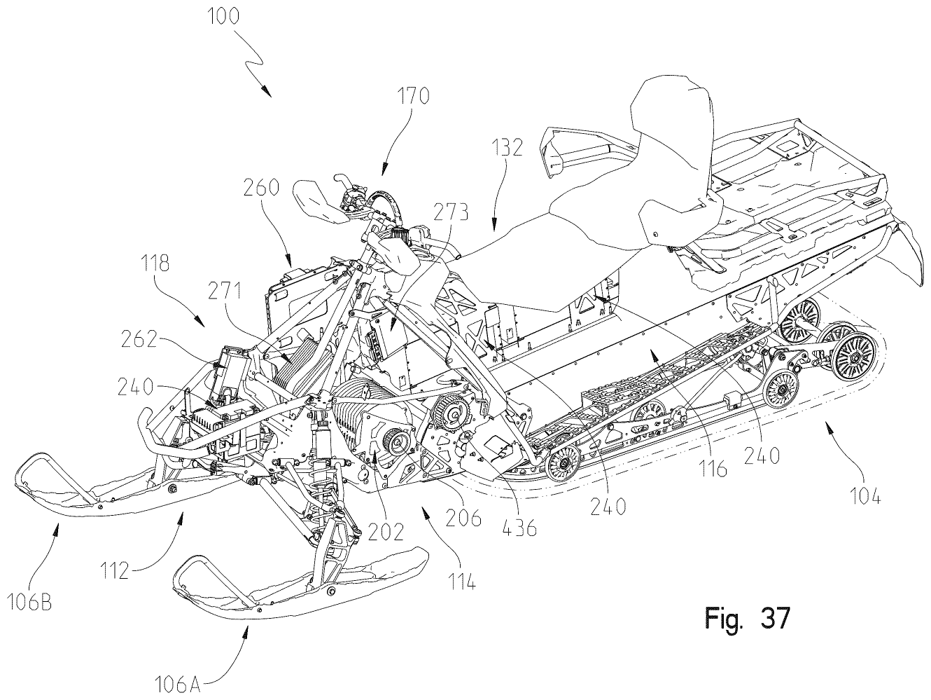

Electronic controller 270 is shown mounted to front frame portion 112 of structural frame 110 and centered along longitudinal vertical plane 108. In embodiments, wherein electronic controller 270 is a distributed controller, the electronic controller 270 shown in FIG. 30 is a motor controller for electric motor assembly 202. An advantage, among others of positioning electronic controller 270 on a leading edge of front frame portion 112 is that electronic controller 270 receives ambient air to cool electronic controller 270. In embodiments, electronic controller 270 is mounted to one of middle frame portion 114, tunnel 116, or overstructure 118. In embodiments, electronic controller 270 or at least a motor controller of electronic controller 270 is positioned adjacent to electric motor assembly 202, such as in middle frame portion 114 under overstructure 118 in FIG. 37. Advantages, among others, of this placement of the motor controller and electric motor assembly 202 is to reduce the length of high voltage wire needed to couple electric motor assembly 202 and the motor controller and to improve cooling performance be directing air flow from a hood 105 (see FIG. 1) or other body work 103 (see FIG. 1) of snowmobile 100 towards the motor controller and electric motor assembly 202.

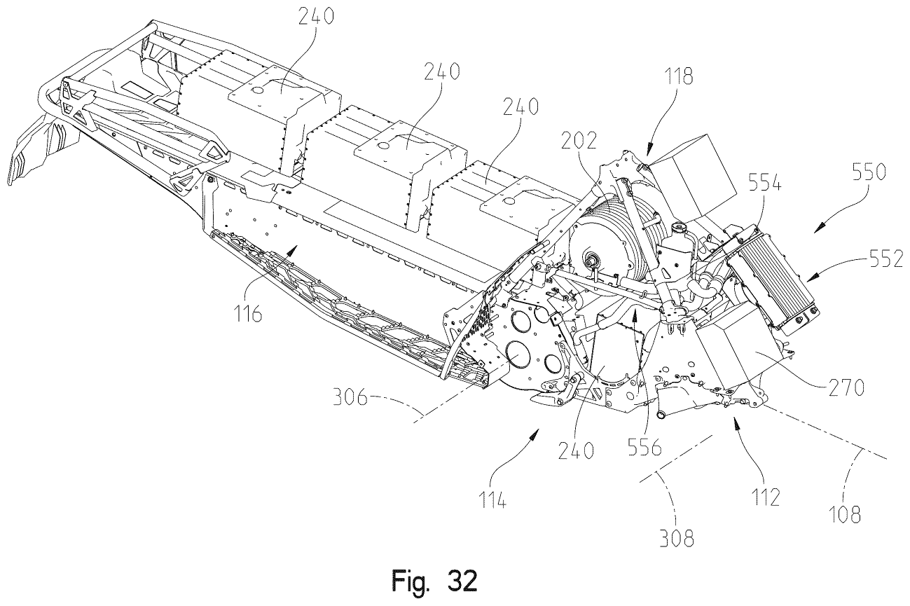

Referring to FIG. 32, another exemplary layout of some components of electric powertrain assembly 200 for snowmobile 100 are shown. As shown in FIG. 32, battery assemblies 240 have a first portion positioned longitudinally between vertical lateral plane 306 and vertical lateral plane 308 and a second portion positioned longitudinally rearward of vertical lateral plane 306.

A single electric motor assembly 202 is positioned longitudinally between vertical lateral plane 306 and vertical lateral plane 308 and above the first portion of battery assemblies 240. As illustrated electric motor assembly 202 is centered about longitudinal vertical plane 108. In embodiments, electric motor assembly 202 is completely to one side of longitudinal vertical plane 108.

In embodiments, the first portion of battery assemblies 240 is positioned completely above electric motor assembly 202. In embodiments, the first portion of battery assemblies 240 is positioned both above electric motor assembly 202 and below electric motor assembly 202. In embodiments, the first portion of battery assemblies 240 may be positioned laterally offset from electric motor assembly 202 such that electric motor assembly 202 is completely to one side laterally of the first portion of battery assemblies 240.

Electronic controller 270 is shown mounted to front frame portion 112 of structural frame 110 and centered along longitudinal vertical plane 108. In embodiments, wherein electronic controller 270 is a distributed controller, the electronic controller 270 shown in FIG. 32 is a motor controller for electric motor assembly 202. An advantage, among others of positioning electronic controller 270 on a leading edge of front frame portion 112 is that electronic controller 270 receives ambient air to cool electronic controller 270. In embodiments, electronic controller 270 is mounted to one of middle frame portion 114, tunnel 116, or overstructure 118.

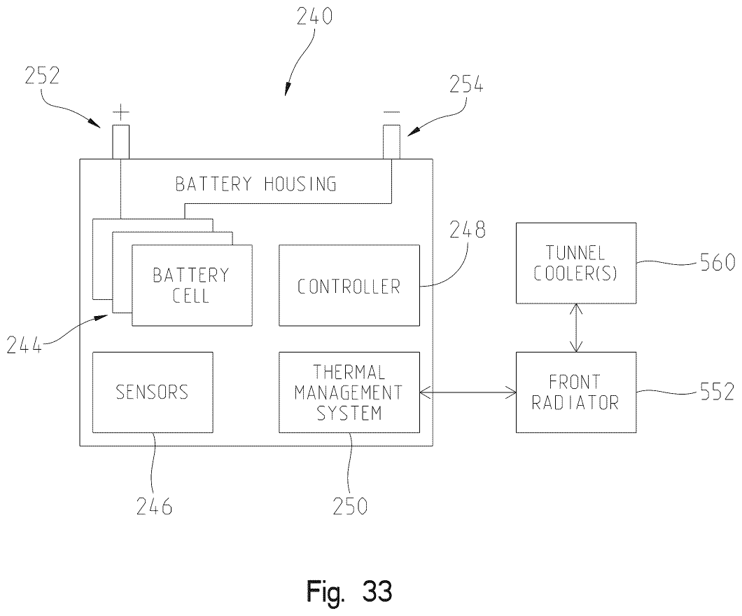

FIG. 32 also includes an active cooling system 550. Active cooling system 550 includes a front radiator 552 coupled to front frame portion 112, a fluid pump 554, and fluid transport conduits 556. Cooling fluid provided by 550 is circulated to thermal management system 250 of battery assembly 240 (see FIG. 33), a thermal management system of a motor controller of electronic controller 270, and/or a similar thermal management system of electric motor assembly 202. In embodiments, active cooling system 550 also includes at least one tunnel cooler 560. Exemplary tunnel coolers and cooling systems are disclosed in U.S. Pat. No. 11,142,286, titled SNOWMOBILE; U.S. Pat. No. 8,567,546 titled VEHICLE COOLING SYSTEM; and U.S. Pat. No. 8,490,731 titled SNOWMOBILE, the entire disclosures of which are expressly incorporated by reference herein. In embodiments, active cooling system 550 provides cooling fluid to a thermal management system of a motor controller of electronic controller 270. In embodiments, active cooling system 550 provides cooling fluid to a thermal management system of a motor controller of electronic controller 270 and a thermal management system 250 of battery assemblies 240. In embodiments, active cooling system 550 provides cooling fluid to a thermal management system of a motor controller of electronic controller 270, a thermal management system 250 of battery assemblies 240, and a thermal management system of electric motor assembly 202.

Further, as illustrated in FIG. 32 and FIG. 19, electric motor assembly 202 is positioned such that at least the drive shaft is higher than the front edge of the tunnel 116 and optionally all of electric motor assembly 202 is positioned higher than the front edge of the tunnel 116. An advantage, among others, of this placement of the electric motor assembly 202 is to permit at least a portion of battery assemblies 240 to be positioned lower in middle frame portion 114 to lower the center of mass of vehicle 100 in situations wherein the portion of the battery assemblies weighs more than electric motor assembly 202. Additionally or alternatively, electric motor assembly is positioned longitudinally proximate the front of tunnel 116. Advantages, among others, of this placement of electric motor assembly 202 is to reduce the length of conduit needed to transport fluid from tunnel coolers 560 to electric motor assembly 202. Advantages, among others, of this placement of the electric motor assembly 202 are to reduce the fluid circuit length and to reduce the weight of vehicle 100.

In embodiments, each of at least one battery assembly 240 and electric motor assembly 202 form part of structural frame 110. In embodiments, battery assembly 240 and electric motor assembly 202 are directly fastened together. In embodiments, battery assembly 240 and electric motor assembly 202 are separated by another component of structural frame 110 and are thereby indirectly fastened together.

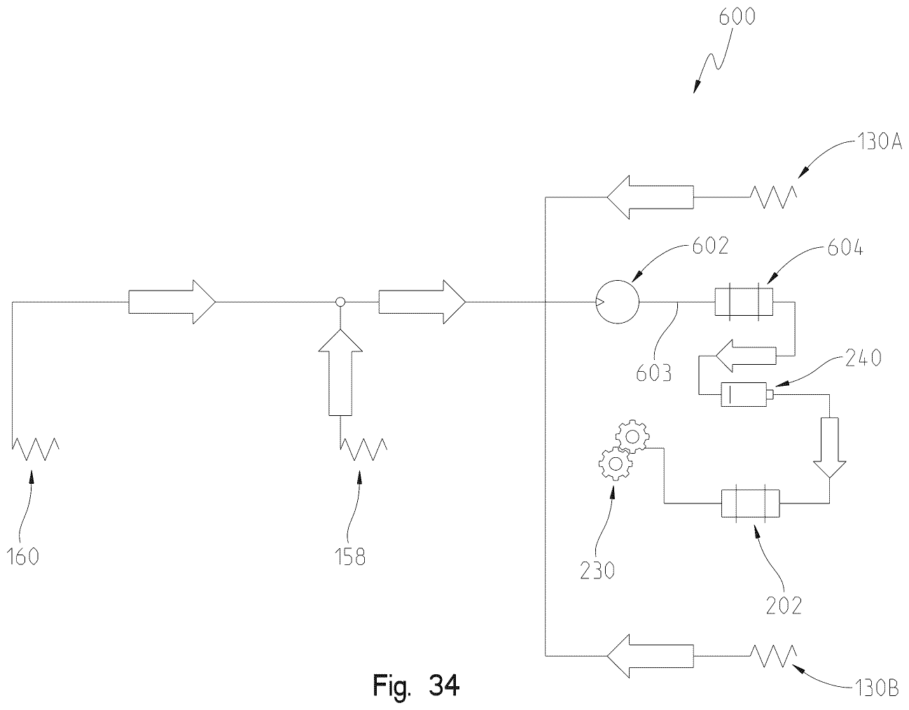

Referring to FIG. 34, a kinetic energy recovery system 600 is illustrated. As shown in FIG. 34, each of or optionally at least one of shock absorber 130A, shock absorber 130B, front shock absorber 158, and rear shock absorber 160 are hydraulically coupled to a hydraulic pump 602 to cause a rotation of an output 603 of hydraulic pump 602. Output 603 is operatively coupled to the output shaft of an electric motor 604 to generate electrical energy. The generated electrical energy is provided to battery assembly 240 to charge battery assembly 240. In embodiments, kinetic energy recovery system 600 also includes energy capture from a brake system of snowmobile 100.

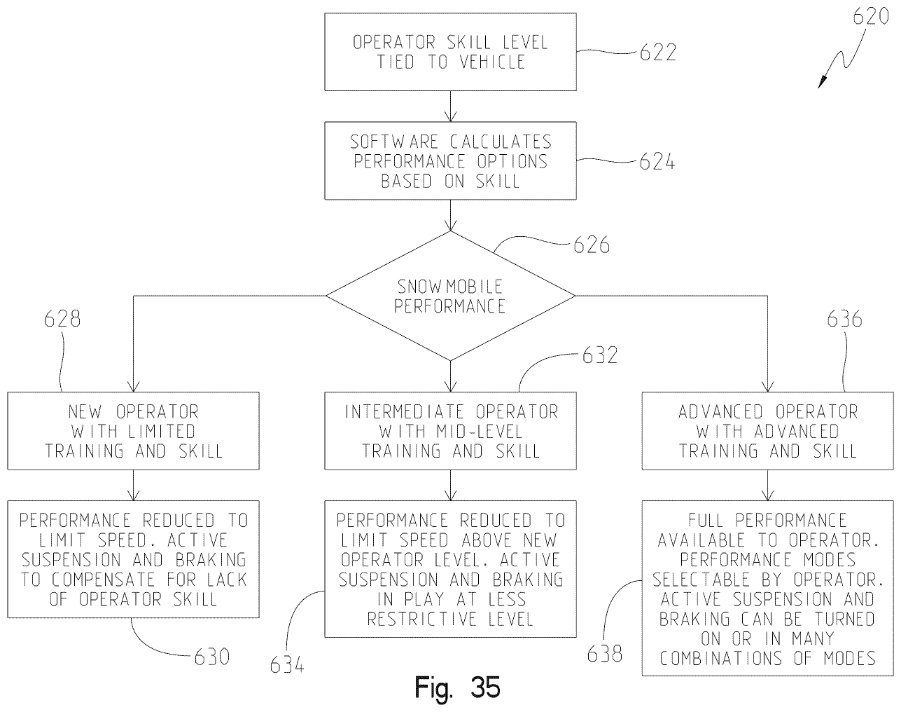

Referring to FIG. 35, an exemplary processing sequence 620 is shown. In processing sequence 620, various performance characteristics of snowmobile 100 are set based on a characteristic of the intended operator. Some fleet operators (rental, ski-resort, etc.) may want to limit performance of snowmobile 100 based on characteristics, such as the skill level and the training of the operator. An indication of the characteristic of the intended operator, such as skill level, is received by electronic controller 270, as represented by block 622. In embodiments, this indication may be a value to indicate a level of skill of the operator, such as “1” for limited skill, “2” for intermediate skill, and “3” for advanced skill. The indication may be input through one of input device 282. The indication may be received over a network, such as a wireless network, a wired network, or a combination thereof. The indication may be provided on a dongle which is plugged into snowmobile 100.

Electronic controller 270 determines performance options of snowmobile 100 based on the indication of the skill level of the intended operator, as represented by blocks 624 and 626. In the case of limited skill, the performance parameters are set to limit a speed of snowmobile 100 and both active suspension with one or more of shock absorber 130A, shock absorber 130B, front shock absorber 158, and rear shock absorber 160 and active braking are activated, as represented by blocks 628 and 630. In the case of intermediate skill, the performance parameters are set to limit a speed of snowmobile 100 which is higher than the speed limit of the limited skill setting and both active suspension with one or more of shock absorber 130A, shock absorber 130B, front shock absorber 158, and rear shock absorber 160 and active braking are activated, as represented by blocks 632 and 634. In the case of advanced skill, the performance parameters are set to not limit a speed of snowmobile 100, to provide the operator to select between various performance modes, and to activate or deactivate one or more of active suspension with one or more of shock absorber 130A, shock absorber 130B, front shock absorber 158, and rear shock absorber 160 and active braking, as represented by blocks 636 and 638.

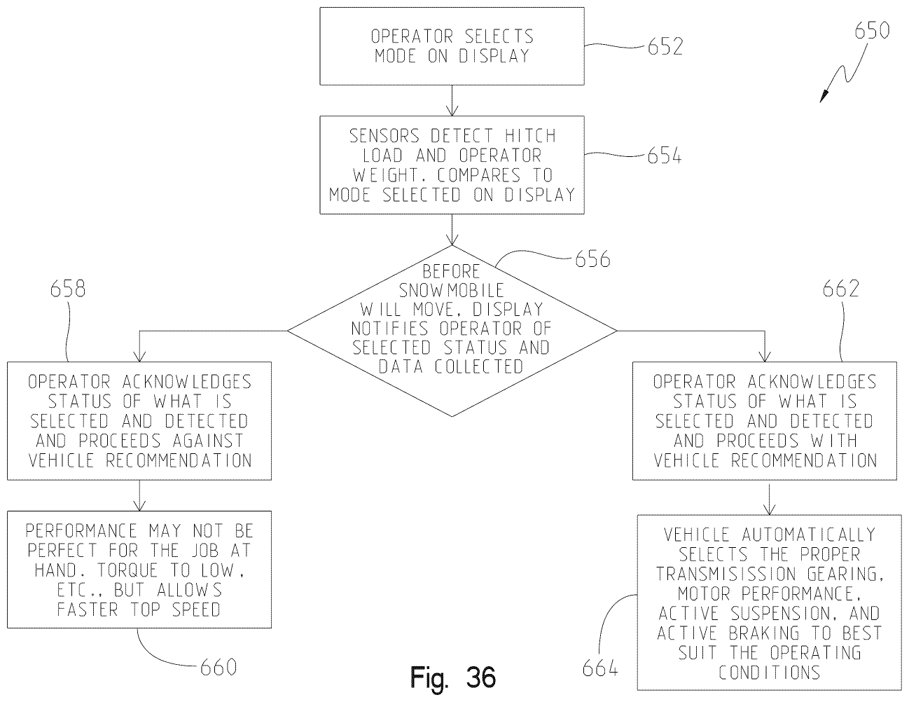

Referring to FIG. 36, an exemplary processing sequence 650 is shown. In processing sequence 650, an operator selects a mode for snowmobile 100 with input device 282, such as a touch display, as represented by block 652. Electronic controller 270 receives values from a plurality of sensors of snowmobile 100 to detect various vehicle characteristics, such as a hitch load, an operator weight, and compares those values to acceptable ranges for the selected mode, as represented by block 654. If a value of the detected vehicle characteristics are outside of the acceptable ranges, then prior to permitting snowmobile 100 to move electronic controller 270 display on a display of output devices 284 of the selected mode and a recommendation of a different mode based on the detected vehicle values, as represented by block 656. The operator through input device 282 may acknowledge and select the different mode and electronic controller 270 configures snowmobile 100 to operate in the different mode, as represented by blocks 662 and 664. The operator through input device 282 may also decline to accept the different mode and to proceed with the current selected mode, as represented by blocks 658 and 660.

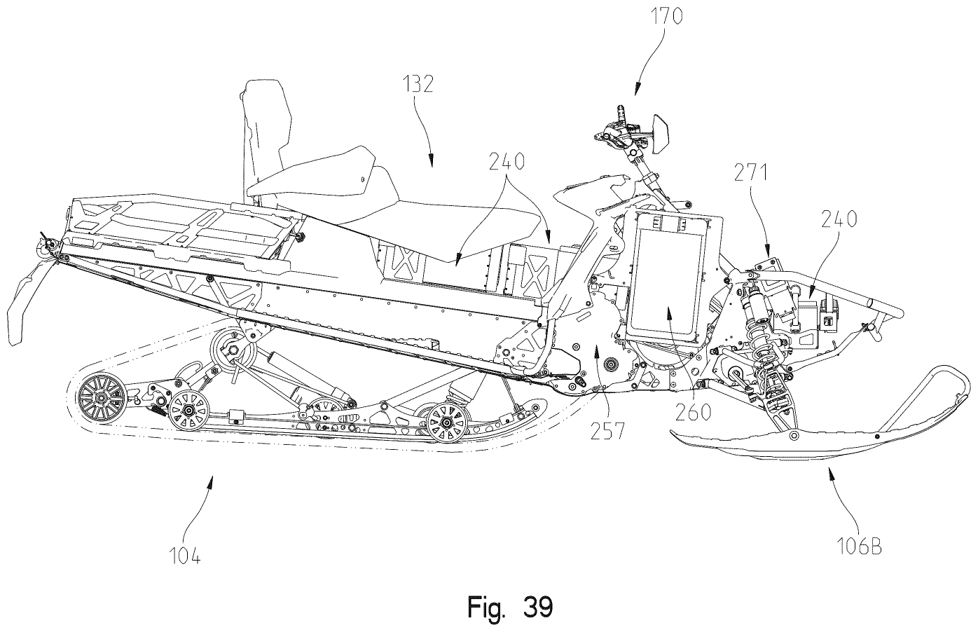

Referring to FIGS. 37-39, an exemplary layout for snowmobile 100 is shown. In the embodiment of FIGS. 37-39, electric motor assembly 202 is positioned forward of tunnel 116 supported by middle frame portion 114 with drive shaft 206 extending laterally leftward. Driveshaft 206 is operatively coupled to rotatable jackshaft 436 through an endless coupler (not shown), such as a chain or belt. As mentioned herein, rotatable jackshaft 436 is operatively coupled to drive sprocket 144 through a gearcase 257 (FIG. 39) or other coupling arrangement.

In embodiments, drive shaft 206 is operatively coupled to rotatable jackshaft 436 through a continuously variable transmission (CVT). Exemplary CVTs include standard CVTs wherein the effective gear ratio is controlled by weights which alter sheave separations and electronically controlled CVTs wherein sheave separations and hence the effective gear ratio are at least partially controlled by electronically controlled actuators. Exemplary CVTs are disclosed in U.S. Pat. Nos. 3,727,478; 4,023,635; 6,176,796; 7,070,527; and 11,085,528, the entire disclosures of which are expressly incorporated by reference herein.

Returning to FIG. 37, charger 260 is positioned forward of tunnel 116 supported by middle frame portion 114 and laterally rightward. A motor controller 271 of electronic controller 270 is supported by middle frame portion 114, or alternatively front frame portion 112, and generally positioned between a leftward lateral extent of electric motor assembly 202 and a rightward lateral extent of charger 260. Airflow through body work 103 of snowmobile 100, such as hood 105, may be directed to motor controller 271 of electronic controller 270 to cool motor controller 271 of electronic controller 270 and/or to electric motor assembly 202 and/or battery assembly 240 to cool electric motor assembly 202 and/or electric motor assembly 202. A vehicle controller 273 of electronic controller 270 is supported by overstructure 118. DC-DC converter 262 is supported by front frame portion 112. A first battery assembly 240 is supported by front frame portion 112 and multiple battery assemblies 240 are supported by tunnel 116.

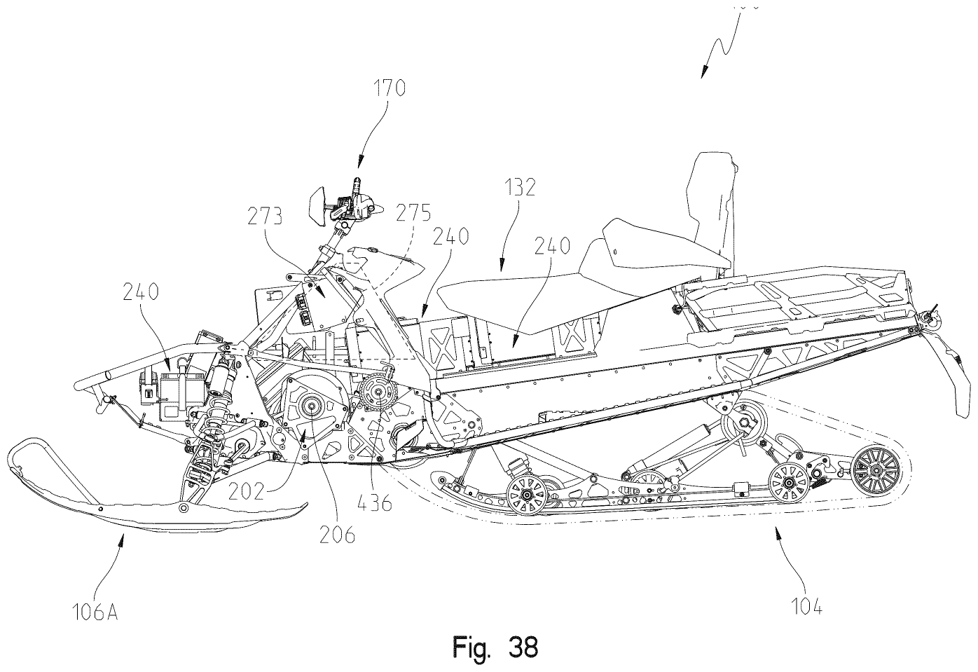

Referring to FIG. 38, due to the placement of electric motor assembly 202, charger 260, motor controller 271, and battery assembly 240, space 275 within overstructure 118 and middle frame portion 114 along longitudinal vertical centerline plane 108 is generally available for storage. In embodiments, bodywork 103 includes at least one door or removable portion providing access to a storage area within space 275.

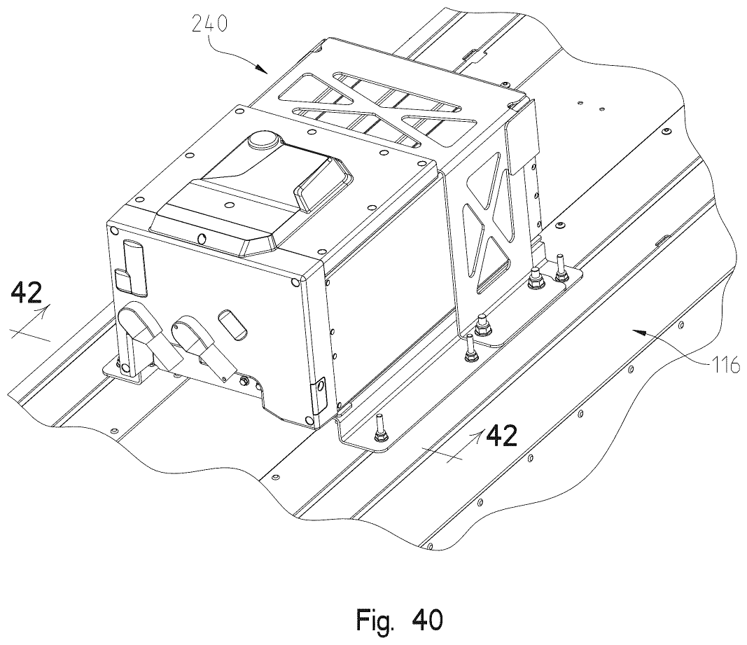

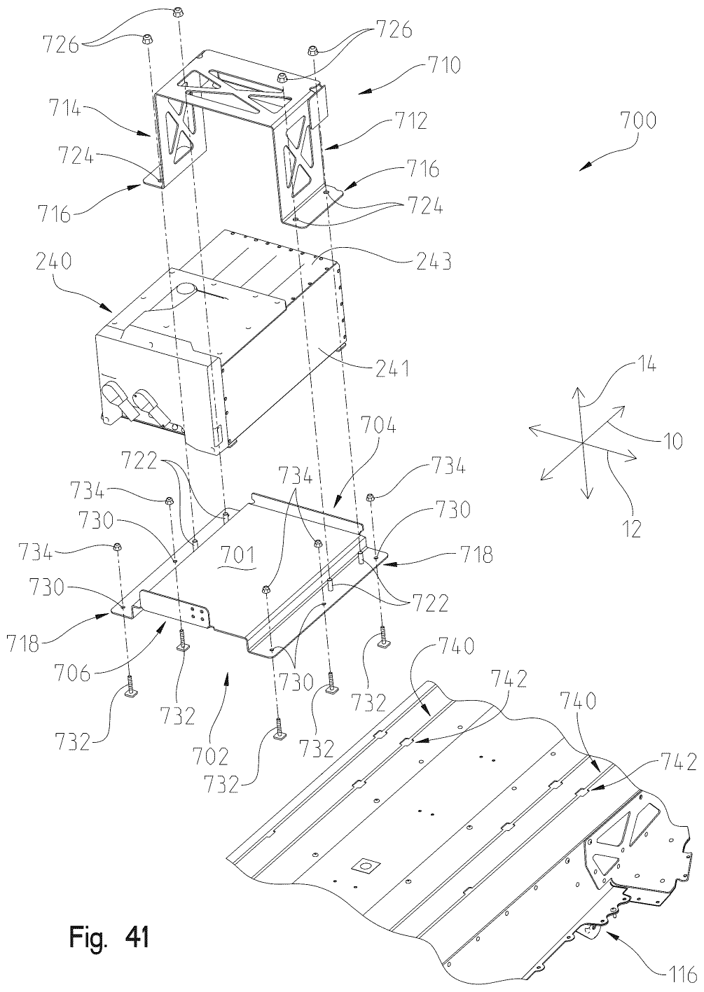

Referring to FIGS. 40-42, an exemplary mounting assembly 700 for battery assemblies 240 on tunnel 116 is shown. Referring to FIG. 41, mounting assembly 700 includes a support 702 which supports battery assembly 240 relative to tunnel 116. Support 702 includes an upper surface which contacts battery assembly 240. Support 702 further includes a rearward stop 704 and a forward stop 706 which captures battery assembly 240 in a longitudinal direction 10 when supported on upper surface 701 of support 702.

Mounting assembly 700 further includes a cover 710 which is positioned over at least a part of battery assembly 240. Cover 710 includes a left wall 712 and a right wall 714 which capture battery assembly 240 in a lateral direction 12. Each of walls 712, 714 have a respective wing 716 which is positioned adjacent respective wings 718 of support 702. Studs 722 of support 702 are received in apertures 724 of wings 716 of cover 710. Retainers 726 are threaded onto studs 722 to couple cover 710 to support 702 and capture battery assembly 240 in a vertical direction 14.

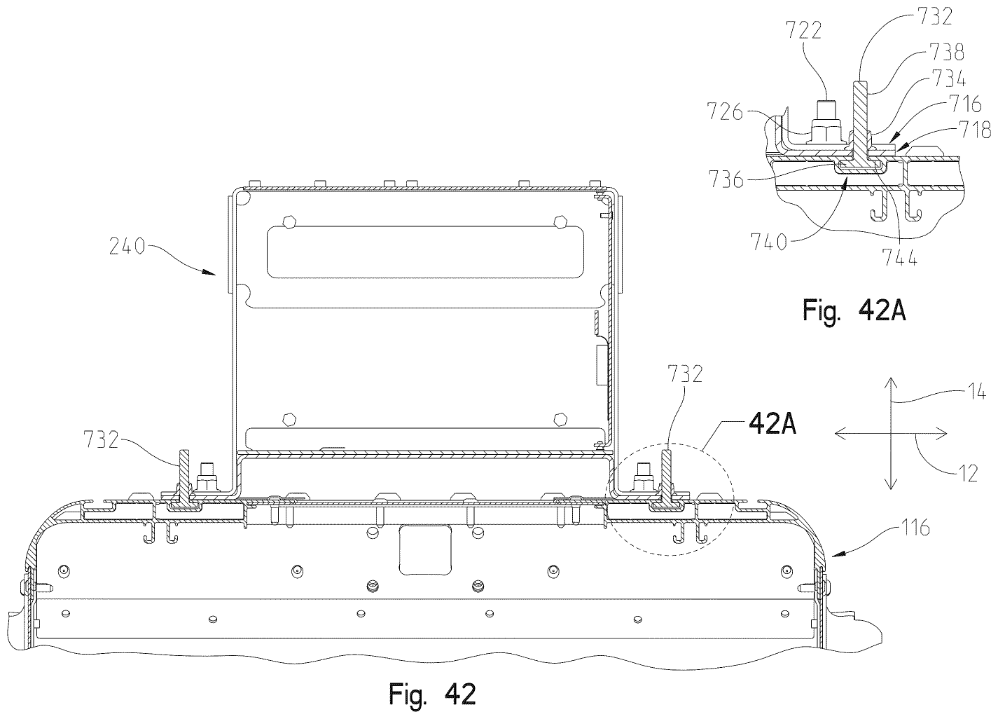

Support 702 includes apertures 730 in wings 718. Apertures 730 receive locators 732. Referring to FIG. 42A locators 732 include a head 736 received in a channel 740 of tunnel 116. Channel 740 is sized to retain head 736 in lateral direction 12 and vertical direction 14. In embodiments, head 736 has a polygonal shape, such as quadrilateral, which are sized to minimize spinning of locators 732 when placed in channel 740. Head 736 may enter channel 740 through enlarged openings 742 in tunnel 116 (see FIG. 41) and/or from a longitudinal end of tunnel 116. A threaded stud 738 of locators 732 passes through respective ones of apertures 730 in wings 718. Retainers 734 are threaded onto respective studs 738 of locators 732. As retainers 734 are tightened, head 736 of locator 732 are drawn into contact with upper surface 744 of channel 740 to hold battery assembly 240 in longitudinal direction 10 along tunnel 116. When the retainers 734 are tightened to hold battery assembly 240, the mounting assembly is in a locked state and when retainers 734 are loosened so that battery assembly 240 may move in longitudinal direction 10, the mounting assembly is in an unlocked state.

An advantage, among others, of coupling battery assembly 240 to tunnel 116 is that the longitudinal placement of battery assembly 240 along tunnel may be adjusted to alter the center of mass of snowmobile 100. Although mounting assembly 700 is illustrated supporting a single battery assembly, a given mounting assembly may be sized and shaped to support multiple battery assemblies 240. Further, multiple mounting assemblies 700 may be provided to permit the mounting location of multiple battery assemblies to be individually adjusted.

For example, a battery assembly 240 may be cantilevered off a front of tunnel 116 (see FIGS. 37 and 38). As such, the battery assembly 240 may both be supported by tunnel 116 and extend forward of endless track assembly 104. In embodiments, battery assembly 240 may be further supported by other portions of structural frame 110, such as middle frame portion 114 and/or overstructure 118.

Example 1: A snowmobile is provided. The snowmobile comprising: a plurality of ground engaging members including an endless track positioned along a vertical centerline plane of the snowmobile, a left front ski, and a right front ski. The endless track being positioned rearward of the left front ski and the right front ski. The snowmobile further comprising an electric powertrain operatively coupled to the endless track to power movement of the endless track; a structural frame supported by the plurality of ground engaging members, the structural frame provides structural rigidity for the snowmobile and includes a first component of the electric powertrain; a rear suspension positioned in an interior of the endless track and movably coupled to the structural frame; a left front suspension movably coupled to the structural frame and to the left front ski; a right front suspension movably coupled to the structural frame and to the right front ski; a steering assembly supported by the structural frame and operatively coupled to the left front ski and the right front ski to steer the snowmobile, the steering assembly including an operator steering input and a steering post; and a straddle seat positioned along the vertical centerline plane of the snowmobile over the endless track and positioned longitudinally rearward of the steering post of the steering assembly.

Example 2: The snowmobile of Example 1, wherein the structural frame includes a rear portion including a tunnel, a front portion positioned forward of the tunnel, and an overstructure which supports the steering assembly and extends over the front portion, the front portion being movably coupled to the left front suspension and the right front suspension.

Example 3: The snowmobile of Example 2, wherein the first component is part of a battery assembly.

Example 4: The snowmobile of Example 3, wherein the battery assembly includes a battery housing and at least one battery and the first component is the battery housing of the battery assembly, the battery housing including an interior to receive the at least one battery.

Example 5: The snowmobile of Example 2, wherein the first component is part of a motor assembly.

Example 6: The snowmobile of Example 5, wherein the motor assembly includes a motor housing and at least one output shaft and the first component is the motor housing.

Example 7: The snowmobile of one of Examples 3-6, wherein the first component forms part of the tunnel of the structural frame.

Example 8: The snowmobile of one of Examples 3-6, wherein the first component forms part of the front portion of the structural frame.

Example 9: The snowmobile of one of Examples 3-6, wherein the first component forms part of the overstructure of the structural frame.

Example 10: The snowmobile of any one of Examples 3-6, wherein the structural frame includes a middle portion longitudinally between the front portion and the tunnel and the first component forms part of the middle portion of the structural frame.

Example 11: A snowmobile is provided. The snowmobile comprising a plurality of ground engaging members including an endless track positioned along a vertical centerline plane of the snowmobile, a left front ski, and a right front ski. The endless track being positioned rearward of the left front ski and the right front ski. The snowmobile further comprising an electric powertrain operatively coupled to the endless track to power movement of the endless track, the electric powertrain including at least one planetary gearset; a structural frame supported by the plurality of ground engaging members, the structural frame provides structural rigidity for the snowmobile; a rear suspension positioned in an interior of the endless track and movably coupled to the structural frame; a left front suspension movably coupled to the structural frame and to the left front ski; a right front suspension movably coupled to the structural frame and to the right front ski; a steering assembly supported by the structural frame and operatively coupled to the left front ski and the right front ski to steer the snowmobile, the steering assembly including an operator steering input and a steering post; and a straddle seat positioned along the vertical centerline plane of the snowmobile over the endless track and positioned longitudinally rearward of the steering post of the steering assembly.

Example 12: A snowmobile is provided. The snowmobile comprising a plurality of ground engaging members including an endless track positioned along a vertical centerline plane of the snowmobile, a left front ski, and a right front ski. The endless track being positioned rearward of the left front ski and the right front ski. The snowmobile further comprising a structural frame supported by the plurality of ground engaging members, the structural frame provides structural rigidity for the snowmobile, the structural frame including a tunnel having a forwardmost extent and an electric powertrain operatively coupled to the endless track to power movement of the endless track. The electric powertrain including an electric motor operatively coupled to the endless track and a plurality of battery assemblies operatively coupled to the electric motor, the plurality of battery assemblies including a first battery assembly supported by the tunnel and extending forward of the forwardmost extent of the tunnel.

Example 13: The snowmobile of Example 12, wherein the electric powertrain further includes a continuously variable transmission, the continuously variable transmission having a drive clutch and a driven clutch operatively coupled to the drive clutch, the drive clutch being driven by the electric motor and the endless track being driven by the driven clutch.

Example 14: The snowmobile of Example 12, wherein the electric powertrain further includes an electronically controlled continuously variable transmission, the electronically controlled continuously variable transmission having a drive clutch and a driven clutch operatively coupled to the drive clutch, the drive clutch being driven by the electric motor and the endless track being driven by the driven clutch.

Example 15: The snowmobile of Example 12, wherein the electric powertrain further includes a chain drive which operatively couples the electric motor to the endless track.

Example 16: The snowmobile of Example 12, wherein the electric motor is operatively coupled to the endless track through a portion of the electric powertrain positioned laterally outboard of the first endless track.

Example 17: The snowmobile of Example 12, wherein the first battery assembly is moveable relative to the tunnel.

Example 18: The snowmobile of Example 12, further comprising a mounting assembly to couple the first battery assembly to the tunnel.

Example 19: The snowmobile of Example 18, wherein the mounting assembly permits a movement of the first battery assembly relative to tunnel in a longitudinal direction along the tunnel.

Example 20: The snowmobile of Example 19, wherein the tunnel includes at least one track and the mounting assembly cooperates with the at least one track to limit movement of the first battery assembly in the longitudinal direction along the tunnel.

Example 21: The snowmobile of Example 20, wherein the mounting assembly includes a locked state wherein a longitudinal position of the first battery assembly is locked relative to the tunnel.

Example 22: A snowmobile is provided. The snowmobile comprising a plurality of ground engaging members including an endless track positioned along a vertical centerline plane of the snowmobile, a left front ski, and a right front ski. The endless track being positioned rearward of the left front ski and the right front ski. The snowmobile further comprising a structural frame supported by the plurality of ground engaging members, the structural frame provides structural rigidity for the snowmobile, the structural frame including a tunnel having a forwardmost extent; and an electric powertrain operatively coupled to the endless track to power movement of the endless track. The electric powertrain including an electric motor operatively coupled to the endless track; and a plurality of battery assemblies operatively coupled to the electric motor. The plurality of battery assemblies including a first battery assembly supported by the tunnel and moveable along a longitudinal direction of the tunnel while coupled to the tunnel.

Example 23: The snowmobile of Example 22, further comprising a mounting assembly to couple the first battery assembly to the tunnel.

Example 24: The snowmobile of Example 23, wherein the tunnel includes at least one track and the mounting assembly cooperates with the at least one track to limit movement of the first battery assembly in the longitudinal direction along the tunnel.

Example 25: The snowmobile of Example 23, wherein the mounting assembly includes a locked state wherein a longitudinal position of the first battery assembly is locked relative to the tunnel.

Example 26: A snowmobile is provided. The snowmobile comprising a plurality of ground engaging members including a first endless track, a second endless track, a left front ski, and a right front ski. The first endless track and the second endless track are both positioned rearward of the left front ski and the right front ski. The snowmobile further comprising a structural frame supported by the plurality of ground engaging members, the structural frame provides structural rigidity for the snowmobile, the structural frame including a tunnel; and an electric powertrain operatively coupled to the first endless track and the second endless track to power movement of the first endless track and the second endless track. The electric powertrain including a first electric motor operatively coupled to the first endless track; a second electric motor operatively coupled to the second endless track; and a plurality of battery assemblies operatively coupled to at least one of the first electric motor and the second electric motor. The plurality of battery assemblies including a first portion and a second portion. The first portion being supported by the tunnel and the second portion being positioned forward of the tunnel.

Example 27: A snowmobile having a longitudinal vertical centerline plane is provided. The snowmobile comprising a plurality of ground engaging members including a first endless track, a second endless track, a left front ski, and a right front ski, the first endless track and the second endless track are both positioned rearward of the left front ski and the right front ski. The first endless track having a first lateral outer extent positioned on a first side of the longitudinal vertical centerline plane. The second endless track having a second lateral outer extent positioned on a second side of the longitudinal vertical centerline plane, the second side being opposite the first side. The snowmobile further comprising a structural frame supported by the plurality of ground engaging members, the structural frame provides structural rigidity for the snowmobile, the structural frame including a tunnel; and an electric powertrain operatively coupled to the first endless track and the second endless track to power movement of the first endless track and the second endless track. The electric powertrain including a first electric motor operatively coupled to the first endless track laterally outboard of the first lateral outer extent of the first endless track; a second electric motor operatively coupled to the second endless track laterally outboard of the second lateral outer extent of the second endless track; and a plurality of battery assemblies operatively coupled to at least one of the first electric motor and the second electric motor.

Example 28: The snowmobile of Example 27, wherein the plurality of battery assemblies include a first portion and a second portion, the first portion being supported by the tunnel and the second portion being positioned forward of the tunnel.

Example 29: A snowmobile is provided. The snowmobile comprising a plurality of ground engaging members including an endless track positioned along a vertical centerline plane of the snowmobile, a left front ski, and a right front ski. The endless track being positioned rearward of the left front ski and the right front ski. The snowmobile further comprising a structural frame supported by the plurality of ground engaging members, the structural frame provides structural rigidity for the snowmobile; and an electric powertrain operatively coupled to the endless track to power movement of the endless track. The electric powertrain including a first electric motor operatively coupled to the endless track; a second electric motor operatively coupled to the endless track; and a plurality of battery assemblies operatively coupled to the first electric motor and the second electric motor.

Example 30. The snowmobile of Example 29, wherein the plurality of battery assemblies include a first portion and a second portion, the first portion being supported by the tunnel and the second portion being positioned forward of the tunnel.

Example 31. The snowmobile of Example 29, wherein an output of the first electric motor operatively coupled to the endless track is positioned on a first side of the vertical centerline longitudinal plane and an output the second electric motor operatively coupled to the endless track is positioned on a second side of the vertical centerline longitudinal plane, the second side being opposite the first side.

Example 32: A method of adjusting a center of mass of a snowmobile is provided. The method comprising the steps of: supporting a first battery assembly of an electric powertrain to drive an endless track of the snowmobile to a tunnel of the snowmobile; restraining a movement of the first battery assembly relative to the tunnel to a longitudinal direction of the tunnel; moving the first battery assembly along the longitudinal direction relative to the tunnel from a first position to a second position; and locking the first battery assembly in the second position relative to the tunnel.

Example 33: A method of selecting an operational mode from a plurality of operational modes for an electric powertrain of a snowmobile is provided. The method comprising: monitoring at least one vehicle characteristic; receiving a selected first operational mode of the plurality of operational modes; comparing the monitored vehicle characteristic to an acceptable range for the first selected mode; and if the monitored vehicle characteristic is outside of the acceptable range for the first selected mode, suggesting a second operational mode of the plurality of operational modes.

Example 34: The method of Example 33, wherein the step of suggesting the second operational mode of the plurality of operational modes occurs prior to permitting the snowmobile to move by the electric powertrain.

Example 35: The method of Example 34, further comprising the steps of: displaying on a display of the snowmobile the second operational mode of the plurality of operational modes; receiving an input resulting in selecting the second operational mode of the plurality of operational modes for operation of the snowmobile; and permitting movement of the snowmobile in the second operational mode of the plurality of operational modes.

Example 36: The method of Example 34, further comprising the steps of: displaying on a display of the snowmobile the second operational mode of the plurality of operational modes; receiving an input resulting in selecting the first operational mode of the plurality of operational modes for operation of the snowmobile; and permitting movement of the snowmobile in the first operational mode of the plurality of operational modes.

Example 37: A method of controlling a position of a tensioning wheel of an endless track assembly of a snowmobile. The method comprising: determining an operating state of the snowmobile; if the operating state of the snowmobile is a first state the tensioning wheel is positioned in a first position by an actuator; otherwise, the tensioning wheel is positioned in a second position by the actuator.

Example 38: The method of Example 37, wherein the first position is a raised position relative to the second position.

Example 39: The method of Example 38, wherein the operating state is a direction of travel of the snowmobile.

Example 40: The method of Example 38, wherein the operating state is a direction selection of the snowmobile with an operator input.

Example 41: A method of controlling a position of a tensioning wheel of an endless track assembly of a snowmobile is provided. The method comprising: receive an operator request to move the tensioning wheel; determining an operating state of the snowmobile; and moving the tensioning wheel with an actuator.

Example 42: The method of Example 41, wherein the actuator changes a vertical location of the tensioning wheel.

Example 43: A snowmobile is provided. The snowmobile comprising a plurality of ground engaging members including an endless track positioned along a vertical centerline plane of the snowmobile, a left front ski, and a right front ski, the endless track being positioned rearward of the left front ski and the right front ski. The endless track including a tensioning wheel and an actuator which positions the tensioning wheel. The snowmobile further comprising a structural frame supported by the plurality of ground engaging members, the structural frame provides structural rigidity for the snowmobile; an operator input supported by the structural frame; and an electronic controller operatively coupled to the operator input and the actuator, the electronic controller altering a position of the tensioning wheel with the actuator based on the operator input.

Example 44: The snowmobile of Example 43, wherein the electronic controller alters a height of the tensioning wheel with the actuator based on the operator input.

Example 45: The snowmobile of Example 43, further comprising an electric powertrain operatively coupled to the endless track to power movement of the endless track. The electric powertrain including an electric motor operatively coupled to the endless track and a plurality of battery assemblies operatively coupled to the electric motor.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

1. A snowmobile, comprising:
a plurality of ground engaging members including an endless track positioned along a vertical centerline plane of the snowmobile, a left front ski, and a right front ski, the endless track being positioned rearward of the left front ski and the right front ski;
an electric powertrain operatively coupled to the endless track to power movement of the endless track;
a structural frame supported by the plurality of ground engaging members, the structural frame provides structural rigidity for the snowmobile and includes a first component of the electric powertrain;
a rear suspension positioned in an interior of the endless track and movably coupled to the structural frame;
a left front suspension movably coupled to the structural frame and to the left front ski;
a right front suspension movably coupled to the structural frame and to the right front ski;
a steering assembly supported by the structural frame and operatively coupled to the left front ski and the right front ski to steer the snowmobile, the steering assembly including an operator steering input and a steering post; and
a straddle seat positioned along the vertical centerline plane of the snowmobile over the endless track and positioned longitudinally rearward of the steering post of the steering assembly.

2. The snowmobile of claim 1, wherein the structural frame includes a rear portion including a tunnel, a front portion positioned forward of the tunnel, and an overstructure which supports the steering assembly and extends over the front portion, the front portion being movably coupled to the left front suspension and the right front suspension.

3. The snowmobile of claim 2, wherein the first component is part of a battery assembly.

4. The snowmobile of claim 3, wherein the battery assembly includes a battery housing and at least one battery and the first component is the battery housing of the battery assembly, the battery housing including an interior to receive the at least one battery.

5. The snowmobile of claim 2, wherein the first component is part of a motor assembly.

6. The snowmobile of claim 5, wherein the motor assembly includes a motor housing and at least one output shaft and the first component is the motor housing.

7. The snowmobile of claim 3, wherein the first component forms part of the tunnel of the structural frame.

8. The snowmobile of claim 3, wherein the first component forms part of the front portion of the structural frame.

9. The snowmobile of claim 3, wherein the first component forms part of the overstructure of the structural frame.

10. The snowmobile of claim 3, wherein the structural frame includes a middle portion longitudinally between the front portion and the tunnel and the first component forms part of the middle portion of the structural frame.

11. (canceled)

12. A snowmobile comprising:
a plurality of ground engaging members including an endless track positioned along a vertical centerline plane of the snowmobile, a left front ski, and a right front ski, the endless track being positioned rearward of the left front ski and the right front ski;
a structural frame supported by the plurality of ground engaging members, the structural frame provides structural rigidity for the snowmobile, the structural frame including a tunnel having a forwardmost extent; and
an electric powertrain operatively coupled to the endless track to power movement of the endless track, the electric powertrain including
an electric motor operatively coupled to the endless track; and
a plurality of battery assemblies operatively coupled to the electric motor, the plurality of battery assemblies including a first battery assembly supported by the tunnel and extending forward of the forwardmost extent of the tunnel.

13. The snowmobile of claim 12, wherein the electric powertrain further includes a continuously variable transmission, the continuously variable transmission having a drive clutch and a driven clutch operatively coupled to the drive clutch, the drive clutch being driven by the electric motor and the endless track being driven by the driven clutch.

14. The snowmobile of claim 12, wherein the electric powertrain further includes an electronically controlled continuously variable transmission, the electronically controlled continuously variable transmission having a drive clutch and a driven clutch operatively coupled to the drive clutch, the drive clutch being driven by the electric motor and the endless track being driven by the driven clutch.

15. The snowmobile of claim 12, wherein the electric powertrain further includes a chain drive which operatively couples the electric motor to the endless track.

16. The snowmobile of claim 12, wherein the electric motor is operatively coupled to the endless track through a portion of the electric powertrain positioned laterally outboard of the first endless track.

17. The snowmobile of claim 12, wherein the first battery assembly is moveable relative to the tunnel.

18. The snowmobile of claim 12, further comprising a mounting assembly to couple the first battery assembly to the tunnel.

19. The snowmobile of claim 18, wherein the mounting assembly permits a movement of the first battery assembly relative to tunnel in a longitudinal direction along the tunnel.

20. The snowmobile of claim 19, wherein the tunnel includes at least one track and the mounting assembly cooperates with the at least one track to limit movement of the first battery assembly in the longitudinal direction along the tunnel.

21. The snowmobile of claim 20, wherein the mounting assembly includes a locked state wherein a longitudinal position of the first battery assembly is locked relative to the tunnel.

22.-45. (canceled)
